(19) United States
(12) Patent Application Publication
(10) Pub. No.: US 2004/0205201 A1
(43) Pub. Date: Oct. 14, 2004

(54) System, apparatus, method and program for processing information

(75) Inventors: Tomohiro Katsube, Chiba (JP); Naoshi Suzuki, Chiba (JP)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Corporation, Tokyo (JP)

(21) Appl. No.: 10/727,312

(22) Filed: Dec. 2, 2003

(30) Foreign Application Priority Data
Dec. 2, 2002 (JP) 2002-350280
Oct. 9, 2003 (JP) 2003-351061

(51) Int. Cl. G06F 15/16

(52) U.S. Cl. 709/229; 713/200

(57) ABSTRACT

Upon being connected to a modem, a router gains access to a broadband access server. The router is then authenticated by a RADIUS server, and is then device authenticated by a device authentication server. The router then acquires, from an ISP download server, setting information that is required for connection to an ISP server. The router then sets the acquired setting information in the router itself, and based on the setting information, the router connects to the ISP server, and then acquires HTML on a WEB page over the Internet through the ISP sever. A user is free from time and operation required to input the setting information to the router. The present invention is applied to a variety of electronic devices connected to a network.

### CROSS-REFERENCE TO RELATED APPLICATIONS

The present application claims priority from Japanese Application Nos. 2002-350280 filed Dec. 2, 2002 and 2003-351061 filed Oct. 9, 2003, the disclosures of which are hereby incorporated by reference herein.

### BACKGROUND OF THE INVENTION

The present invention relates to a system, an apparatus, a method, and a program for processing information and, in particular, a system, an apparatus, a method and a program for facilitating setting of a device to be connected to a network.

The Internet currently finds widespread use. A ubiquitous environment is now being realized. In a ubiquitous environment, a television receiver, an audio player, a video deck, a car navigation system, a microwave oven, a refrigerator, a washing machine, and other home appliances are connected to a network such as the Internet, and useful information is exchanged among these apparatuses over the network.

In the discussion that follows, any of a television receiver, an audio player, a video deck, a car navigation system, a microwave oven, a refrigerator, a washing machine, and other home appliances having a networking function is referred to as a consumer electronics (CE) device.

To connect a personal computer and a consumer electronics device to the Internet, a variety of settings must be performed. Beginners sometimes have difficulty with the settings.

A technique facilitating the entry of setting information is available as disclosed in Japanese Unexamined Patent Application Publication No. 2002-169772 (paragraphs 67-80, FIGS. 4 and 6). According to this technique, a network management server sends, to an information processing apparatus owned by a user, server information containing an address of the network management server (such as an Internet Protocol (IP) address), and user information about a user who has subscribed (contracted with) an Internet service provider (ISP), and the information processing apparatus performs a setting process based on the server information and the user information.

Japanese Unexamined Patent Application Publication No. 2002-118618 (pages 4 and 5, and FIG. 29) discloses another technique. According to this technique, a terminal owned by a user presents options of Internet service providers, and accepts an Internet service provider selected by the user. Data required to register the user with the Internet service provider selected by the user is then sent to the user terminal. The user must enter setting information and then set a personal computer or a CE device to connect the personal computer or the CE device to the Internet.

According to the technique disclosed in Japanese Unexamined Patent Application Publication No. 2002-169772, the user must select and enter a predetermined access point geographically closest to the user's own residence. According to the technique disclosed in Japanese Unexamined Patent Application Publication No. 2002-118618, the user must enter the user's name and credit card number.

When a router is connected to the Internet, the user must enter an ID, a password, and an access point to the router through the user's personal computer.

The operation of inputting the setting information is sometimes too complicated for beginners. Even to experienced users, the input of the setting information each time is inconvenient and occasionally creates errors.

Some interfaces of the CE devices are not so well organized as to smoothly accept the setting information. The user thus has difficulty in the input of the setting information.

### SUMMARY OF THE INVENTION

Accordingly, it is an object of the present invention to facilitate the setting of devices in the connection thereof to the Internet.

In a first aspect of the present invention, an information processing system includes a first information processing apparatus operable to authenticate a device, a second information processing apparatus operable to hold setting information required to connect the device to a network, and a third information processing apparatus connected to the network based on the setting information. The first information processing apparatus includes a first storage unit operable to store first identification information for authenticating the third information processing apparatus, and second identification information for identifying the third information processing apparatus; an authenticating unit operable to authenticate the third information processing apparatus based on the first identification information in response to a request from the third information processing apparatus; a generating unit operable to generate third identification information that is used to connect the third information processing apparatus to the second information processing apparatus; a second storage unit operable to store the third identification information in association with the second identification information; a first sending unit operable to send the third identification information to the third information processing apparatus; a first receiving unit operable to receive the third identification information from the second information processing unit; and a second sending unit operable to send the second identification information to the second information processing apparatus. The second information processing apparatus includes a third storage unit operable to store the setting information for connecting the third information processing apparatus to the network in association with the second identification information; a second receiving unit operable to receive the third identification information from the third information processing apparatus; a third sending unit operable to send the received third identification information to the first information processing apparatus; a third receiving unit operable to receive the second identification information from the first information processing apparatus; and a fourth sending unit operable to send the setting information stored in association with the received second identification information to the third information processing apparatus. The third information processing apparatus includes a fourth storage unit operable to store the first identification information; a requesting unit operable to request the first information processing apparatus to authenticate the third information processing apparatus based on the first identification information stored in the fourth storage unit; a fourth receiving unit operable to receive the third identification information from the first information processing apparatus; a fifth sending unit operable to send the received third identification information to the second information processing apparatus; and a fifth receiving unit operable to receive the setting information from the second information processing apparatus.

The first identification information may include a device ID identifying the third information processing apparatus and device authentication information.

The setting information may include information required to connect the third information processing apparatus to the server of an Internet service provider.

In accordance with the information processing system of the present invention, the first information processing apparatus stores the first identification information for authenticating the third information processing apparatus, and the second identification information for identifying the third information processing apparatus. In response to a request from the third information processing apparatus, the first information processing apparatus authenticates the third information processing apparatus based on the first identification information. The first information processing apparatus generates the third identification information that is used to connect the third information processing apparatus to the second information processing apparatus. The generated third identification information is stored in association with the second identification information. The third identification information is sent to the third information processing apparatus. The third identification information is received from the second information processing apparatus, and the second identification information stored in association with the third identification information is then sent to the second information processing apparatus. In the second information processing apparatus, the setting information for connecting the third information processing apparatus to the network is stored in association with the second identification information. When the third identification information is received from the third information processing apparatus, the received third identification information is sent to the first information processing apparatus. The first information processing apparatus receives the second identification information, and the setting information stored in association with the received second identification information is sent to the third information processing apparatus. The third information processing apparatus stores the first identification information, and based on the stored first identification information, the third information processing apparatus requests the first information processing apparatus to authenticate the third information processing apparatus. The third information processing apparatus receives the third identification information from the first information processing apparatus. The received third identification information is sent to the second information processing apparatus. Upon receiving the setting information from the second information processing apparatus, the third information processing apparatus is connected to the network.

In a second aspect of the present invention, an information processing apparatus provides a device to be connected to a network with setting information required for connection to the network. The information processing apparatus includes an authenticating unit operable to authenticate the device based on device identification information identifying the device, and a sending unit operable to send the setting information to the authenticated device.

The information processing apparatus may further include a requesting unit operable to request the device identification information from another apparatus that manages the device identification information, wherein the authenticating unit authenticates the device based on the device identification information received from the another apparatus.

The information processing apparatus may further include a setting information request receiving unit operable to receive a request for the setting information the device has sent based on determining information identifying the information processing apparatus acquired from another apparatus that manages the determining information, wherein the sending unit sends the setting information to the device from which the request for the setting information is received.

The setting information request receiving unit may receive the request for the setting information when the device sends identification information identifying the information processing apparatus to the another apparatus.

The identification information may be selected from among a plurality of pieces of identification information stored in the device.

The present invention in a third aspect relates to an information processing method by which an information processing apparatus provides a device to be connected to a network with setting information required to connect to the network. The information processing method includes authenticating the device based on device identification information identifying the device; and sending the setting information to the authenticated device.

The authenticating step may include acquiring the device identification information from another apparatus that manages the device identification information and authenticating the device based on the acquired device identification information.

The information processing method may further include receiving a request for the setting information the device has sent based on determining information identifying the information processing apparatus acquired from another apparatus that manages the determining information, wherein the sending step includes sending the setting information to the device from which the request for the setting information is received.

The setting information request receiving step may include receiving the request for the setting information when the device sends identification information identifying the information processing apparatus to the another apparatus.

The identification information may be selected from among a plurality of pieces of identification information stored in the device.

The present invention in a fourth aspect relates to a computer program for providing a device to be connected to a network with setting information required to connect to the network. The computer program includes controlling the authentication of the device based on device identification information identifying the device; and controlling the sending of the setting information to the authenticated device.

In the above-referenced information processing apparatus, information processing method, and computer program of the present invention, the device is authenticated based on the device identification information identifying the device, and the setting information is then sent to the authenticated device.

The present invention in a fifth aspect relates to an information processing apparatus connected to a network, and includes a receiving unit operable to receive information identifying a first apparatus that manages setting information required to connect the information processing apparatus to the network; a requesting unit operable to send identification information identifying the information processing apparatus to a second apparatus that is to authenticate the information processing apparatus, and to request the second apparatus to authenticate the information processing apparatus; a sending unit operable to send a result of the authentication by the second apparatus to the first apparatus; and an acquiring unit operable to acquire the setting information from the first apparatus based on the result of authentication sent by the sending unit.

The information processing apparatus may further include an identifying information requesting unit operable to request the first apparatus identifying information from a third apparatus that manages the first apparatus identifying information, wherein the receiving unit receives the first apparatus identifying information sent by the third apparatus in response to the request from the identifying information requesting unit.

The receiving unit may receive the first apparatus identifying information sent by the third apparatus to the information processing apparatus authenticated by the second apparatus.

The identifying information requesting unit may send identification information identifying the first apparatus to the third apparatus and may request the first apparatus identifying information from the third apparatus.

The information processing apparatus may further include a selecting unit operable to select the identification information identifying the first apparatus from among a plurality of pieces of identification information.

The present invention in a sixth aspect relates to an information processing method for an information processing apparatus connected to a network. The information processing method includes receiving information identifying a first apparatus that manages setting information required to connect the information processing apparatus to the network; sending identification information identifying the information processing apparatus to a second apparatus that is to authenticate the information processing apparatus, and requesting the second apparatus to authenticate the information processing apparatus; sending a result of the authentication by the second apparatus to the first apparatus; and acquiring the setting information from the first apparatus based on the result of the authentication sent in the sending step.

The information processing method may further include requesting the first apparatus identifying information from a third apparatus that manages the first apparatus identifying information, wherein the receiving step includes receiving the first apparatus identifying information sent by the third apparatus in response to the request for the first apparatus identifying information.

The receiving step may include receiving the first apparatus identifying information sent by the third apparatus to the information processing apparatus authenticated by the second apparatus.

The identifying information requesting step may include sending identification information identifying the first apparatus to the third apparatus and requesting the first apparatus identifying information from the third apparatus.

The information processing method may further include selecting the identification information identifying the first apparatus from among a plurality of pieces of identification information.

The present invention in a sixth aspect relates to a computer program for processing information in an information processing apparatus connected to a network. The computer program includes controlling the reception of information identifying a first apparatus that manages setting information required to connect the information processing apparatus to the network; controlling the sending of identification information identifying the information processing apparatus to a second apparatus that is to authenticate the information processing apparatus, and the requesting of the second apparatus to authenticate the information processing apparatus; controlling the sending of a result of the authentication by the second apparatus to the first apparatus; and controlling the acquisition of the setting information from the first apparatus based on the result of authentication sent in the sending control step.

In the above-referenced information processing apparatus, information processing method, and computer program of the present invention, the information identifying the first apparatus that manages the setting information required to connect the information processing apparatus to the network is received. The identification information identifying the information processing apparatus is sent to the second apparatus that is to authenticate the information processing apparatus. The second apparatus is requested to authenticate the information processing apparatus. The result of authentication is then sent to the first apparatus. Based on the authentication result, the first apparatus acquires the setting information.

The present invention finds applications in electronic apparatuses connected to a network.

In accordance with the present invention, a user may view a WEB page, etc. over the Internet.

The user can connect an apparatus to the Internet by performing simple operations in accordance with the present invention.

### BRIEF DESCRIPTION OF THE DRAWINGS

FIG. 1 is a block diagram generally illustrating an information processing system implementing the present invention;

FIG. 2 is a block diagram illustrating the structure of a router;

FIG. 3 is a block diagram illustrating the structure of a broadband access server;

FIG. 4 is a block diagram illustrating the structure of a RADIUS server;

FIG. 5 is a block diagram illustrating the structure of a simple setting server;

FIG. 6 is a block diagram illustrating the structure of a device authentication server;

FIG. 7 is a block diagram illustrating the structure of an ISP download server;

FIG. 8 is a block diagram illustrating the structure of an ISP server;

FIG. 9 illustrates a series of process steps of the router starting with the manufacture of the router to the delivery of the router;

FIG. 10 is a flowchart illustrating a registration process;

FIG. 11 illustrates data stored in the ISP download sever;

FIG. 12 is another flowchart illustrating the registration process;

FIG. 13 is a flowchart illustrating a connection setting process of the router;

FIG. 14 is a flowchart illustrating a connection setting process of the broadband access server;

FIG. 15 is a flowchart illustrating a connection process of the RADIUS server;

FIG. 16 is a flowchart illustrating a connection process of the simple setting server;

FIG. 17 is a flowchart illustrating a connection setting process of the device authentication server;

FIG. 18 is a flowchart illustrating a connection setting process of the ISP download server;

FIG. 19 is a flowchart illustrating the connection process of the router;

FIG. 20 is a block diagram illustrating another information processing system implementing the present invention;

FIG. 21 is a block diagram illustrating still another information processing system implementing the present invention;

FIG. 22 is a block diagram of a further information processing system implementing the present invention;

FIG. 23 is a block diagram of a further information processing system implementing the present invention;

FIG. 24 is a block diagram of a still further information processing system implementing the present invention;

FIG. 25 is a block diagram of yet a further information processing system implementing the present invention;

FIG. 26 is a flowchart illustrating a registration process;

FIG. 27 is a flowchart illustrating another registration process;

FIG. 28 illustrates data stored in a simple setting server;

FIG. 29 is a flowchart illustrating another connection setting process of the router;

FIG. 30 is a continuation of the flowchart of FIG. 29;

FIG. 31 is a flowchart illustrating another connection setting process of the simple setting server;

FIG. 32 is a flowchart illustrating another connection setting process of the device authentication server;

FIG. 33 is a continuation of the flowchart of FIG. 32;

FIG. 34 is a flowchart illustrating another connection process of the ISP download server;

FIG. 35 is a block diagram illustrating the structure of another information processing system implementing the present invention;

FIG. 36 is a flowchart illustrating another registration process;

FIG. 37 is a continuation of the flowchart of FIG. 36; and

FIG. 38 is a flowchart of another connection setting process of the router.

### DETAILED DESCRIPTION

Before discussing the preferred embodiments of the present invention, the correspondence between the claimed invention and the preferred embodiments is first described. The description of the correspondence is intended to confirm that the preferred embodiments described in the specification support the invention described in the specification. If any embodiment is not described here but is described later in the specification, it does not mean that the embodiment falls outside the present invention. Conversely, if any embodiment is described here as corresponding to the invention, it may not mean that the embodiment does not correspond to any other invention than the present invention.

The description of the correspondence is not intended to mean that all of the invention described in the specification is claimed. In other words, the description of the correspondence does not negate the presence of an unclaimed invention described in the specification. Specifically, the description of the correspondence does not rule out the possibility that any unclaimed invention may be applied for, in the future, in divisional applications, or in the form of an amendment or an addition to the original patent application.

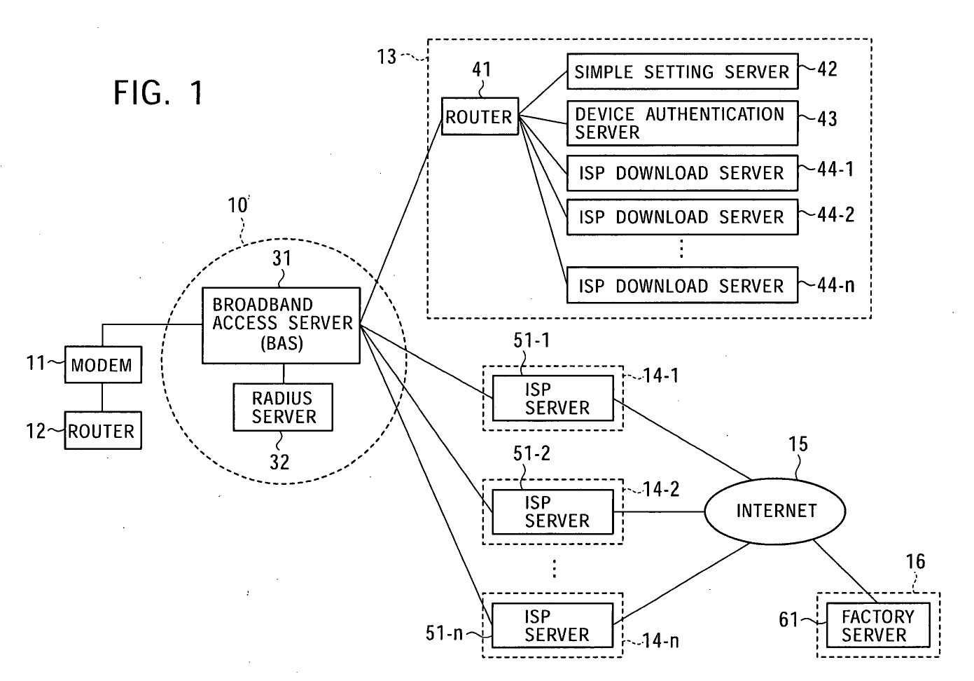

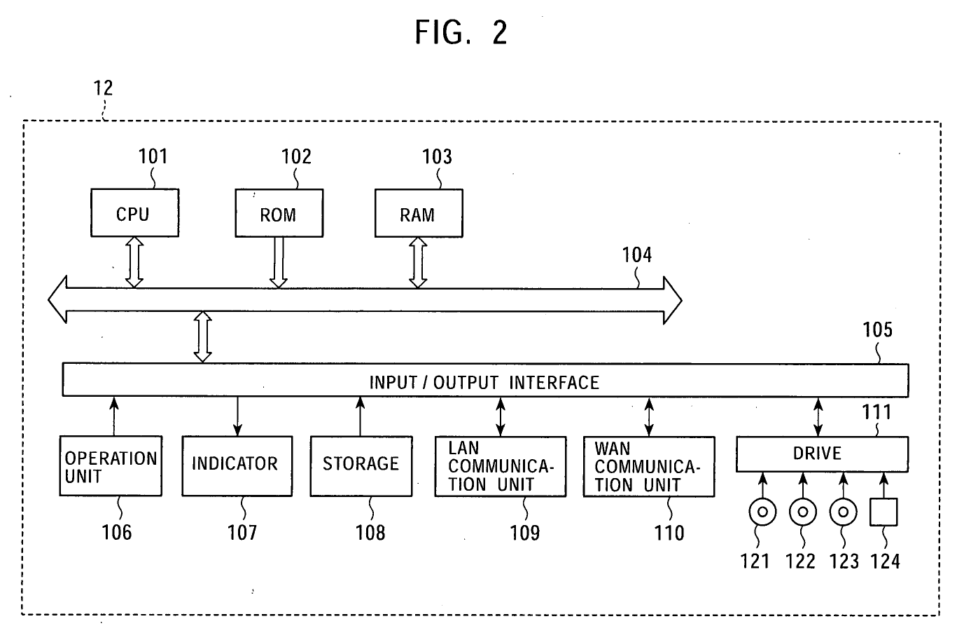

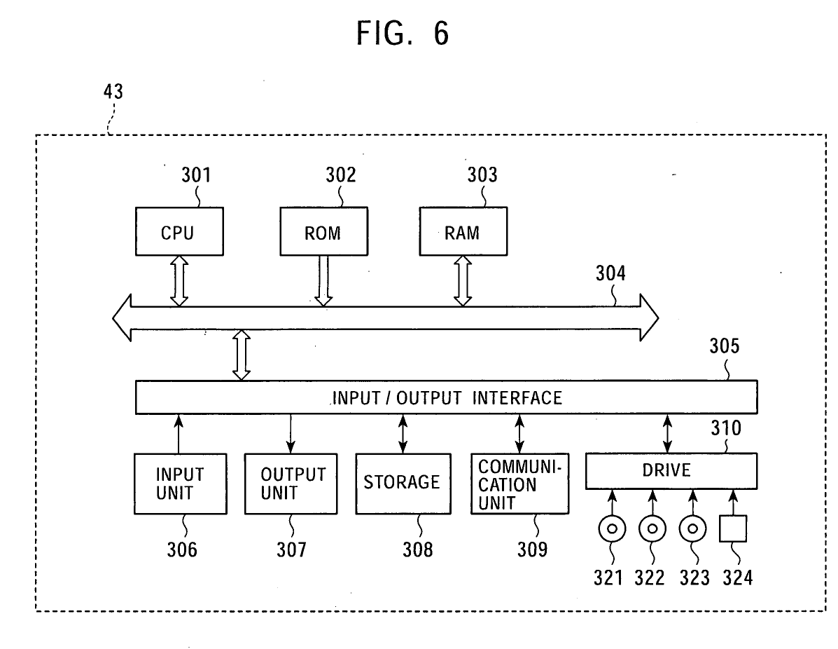

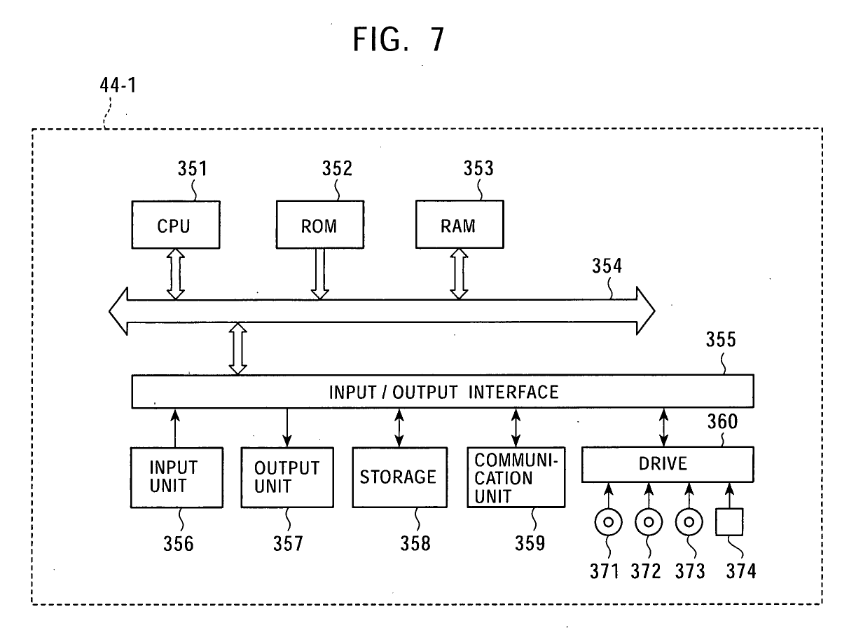

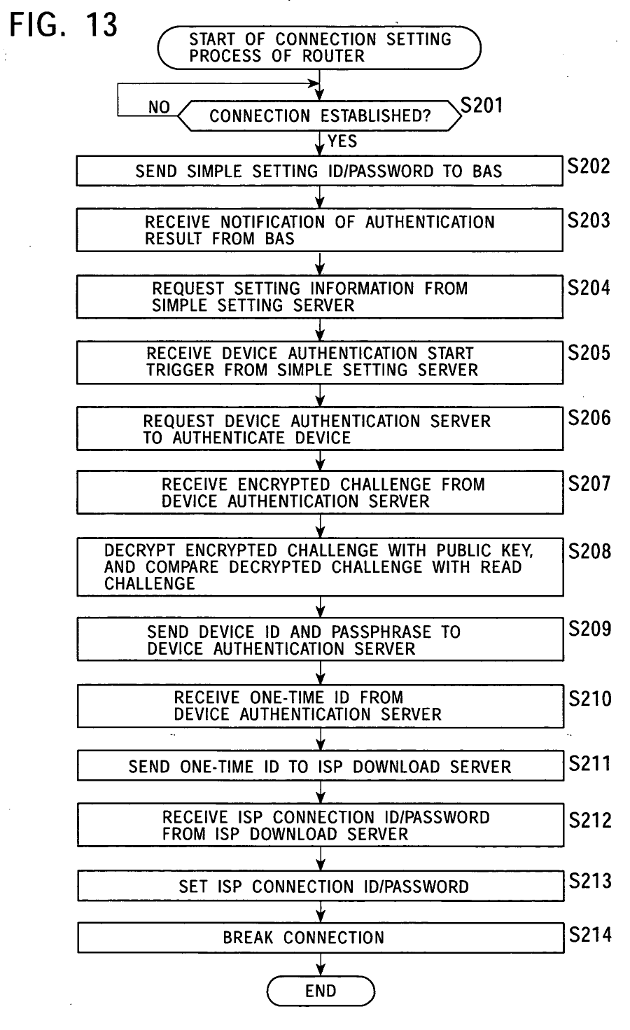

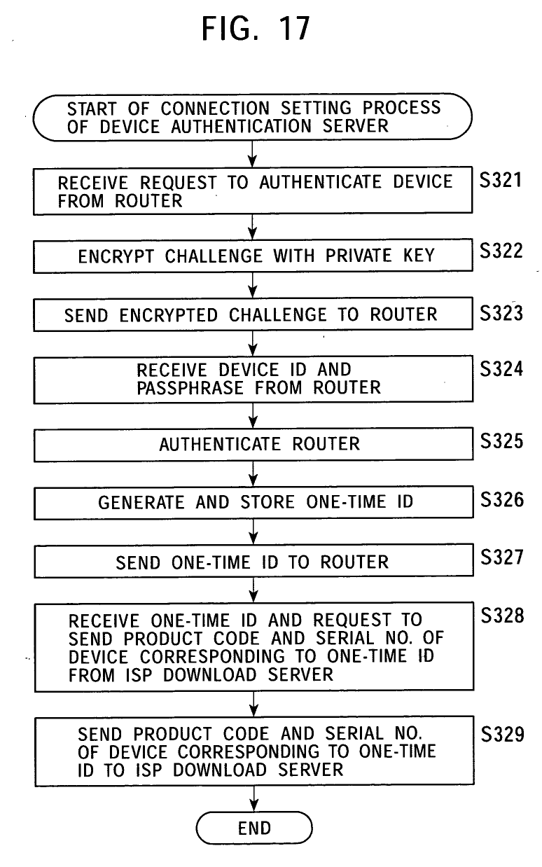

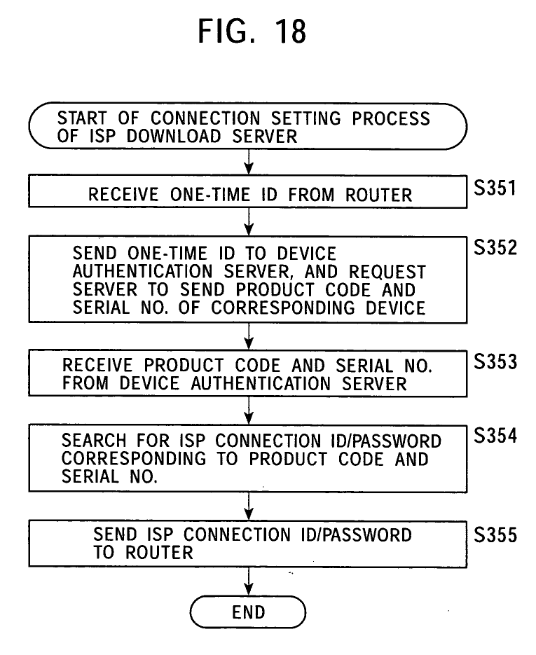

The present invention provides an information processing system. The information processing system includes a first information processing apparatus (a device authentication server 43 shown in FIG. 1, for example) operable to authenticate a device, a second information processing apparatus (an ISP download server 44-1 shown in FIG. 1, for example) operable to hold setting information (an ISP connection ID and a password, for example) required to connect the device to a network (the Internet 15 shown in FIG. 1, for example), and a third information processing apparatus (a router 12 shown in FIG. 1, for example) connected to the network based on the setting information. The first information processing apparatus includes a first storage unit (a storage 308 shown in FIG. 6, for example) operable to store first identification information (a device ID and a passphrase, for example) for authenticating the third information processing apparatus, and second identification information (a product code and a serial number, for example) for identifying the third information processing apparatus, an authenticating unit (a CPU 301 shown in FIG. 6 performing a process step in step S325 as shown in FIG. 17, for example) operable to authenticate the third information processing apparatus based on the first identification information in response to a request from the third information processing apparatus, a generating unit (the CPU 301 shown in FIG. 6 performing a process step in step S326 as shown in FIG. 17, for example) operable to generate third identification information (a one-time ID, for example) that is used to connect the third information processing apparatus to the second information processing apparatus, a second storage unit (the storage 308 shown in FIG. 6, for example) operable to store the third identification information in association with the second identification information, a first sending unit (the CPU 301 shown in FIG. 6 performing a process step in step 327 as shown in FIG. 17, for example) operable to send the third identification information to the third information processing apparatus, a first receiving unit (the CPU 301 shown in FIG. 6 performing a process step in step S328 as shown in FIG. 17, for example) operable to receive the third identification information from the second information processing unit, and a second sending unit (the CPU 301 shown in FIG. 6 performing a process step in step S329 as shown in FIG. 17) operable to send the second identification information to the second information processing apparatus. The second information processing apparatus includes a third storage unit (a storage 358 shown in FIG. 7, for example) operable to store the setting information for connecting the third information processing apparatus to the network in association with the second identification information, a second receiving unit (a CPU 351 shown in FIG. 7 performing a process step in step S351 as shown in FIG. 18) operable to receive the third identification information from the third information processing apparatus, a third sending unit (the CPU 351 shown in FIG. 7 performing a process step in step S352 as shown in FIG. 18) operable to send the received third identification information to the first information processing apparatus, a third receiving unit (the CPU 351 shown in FIG. 7 performing a process step in step S353 as shown in FIG. 18) operable to receive the second identification information from the first information processing apparatus, and a fourth sending unit (the CPU 351 shown in FIG. 7 performing a process step in step S355 as shown in FIG. 18) operable to send the setting information stored in association with the received second identification information to the third information processing apparatus. The third information processing apparatus includes a fourth storage unit (a ROM 102 shown in FIG. 2, for example) operable to store the first identification information, a requesting unit (a CPU 101 shown in FIG. 2 performing a process step in step S206 as shown in FIG. 13) operable to request the first information processing apparatus to authenticate the third information processing apparatus based on the first identification information stored in the fourth storage unit, a fourth receiving unit (the CPU 101 shown in FIG. 2 performing a process step in step S210 as shown in FIG. 13) operable to receive the third identification information from the first information processing apparatus, a fifth sending unit (the CPU 101 shown in FIG. 2 performing a process step in step S211 as shown in FIG. 13) operable to send the received third identification information to the second information processing apparatus, and a fifth receiving unit (the CPU 101 shown in FIG. 2 performing a process step in step S212 as shown in FIG. 13) operable to receive the setting information from the second information processing apparatus.

In accordance with the information processing system of the present invention, the setting information contains information required to connect the third information processing apparatus to the servers of the Internet service provider (ISP servers 51-1 through 51-n shown in FIG. 1, for example).

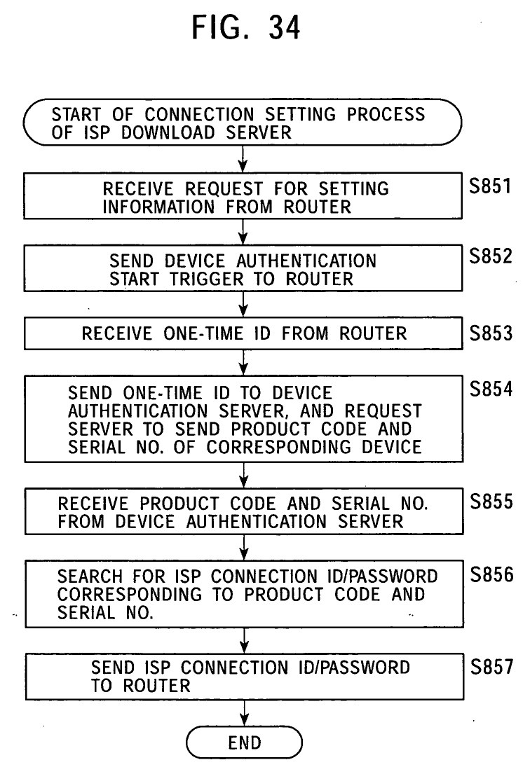

The present invention provides an information processing apparatus. The information processing apparatus (the ISP download server 44-1, for example) provides a device (a router 12 in FIG. 1, for example) to be connected to a network with the setting information (the ISP connection ID and the password, for example) required for connection to the network. The information processing apparatus includes an authenticating unit (the CPU 351 shown in FIG. 7 performing a process step in step S856 as shown in FIG. 34) operable to authenticate the device based on device identification information (the product code and the serial number, for example) identifying the device, and a sending unit (the CPU 351 shown in FIG. 7 performing a process step in step S857 as shown in FIG. 34) operable to send the setting information to the authenticated device.

The information processing apparatus may further include a requesting unit (the CPU 351 shown in FIG. 7 performing a process step in step S854 as shown in FIG. 34) operable to request device identification information from another apparatus (the device authentication server 43 shown in FIG. 1, for example) that manages the device identification information, wherein the authenticating unit authenticates the device based on the device identification information received from the another apparatus.

The information processing apparatus may further include a setting information request receiving unit (the CPU 351 shown in FIG. 7 performing a process step in step S851 as shown in FIG. 34, for example) operable to receive a request for the setting information the device has sent based on determining information identifying the information processing apparatus acquired from another apparatus (a simple setting server 42 shown in FIG. 42, for example) that manages the determining information (a URL of an ISP download server 44, for example), wherein the sending unit sends the setting information to the device from which the request for the setting information is received.

The setting information request receiving unit may receive the request for the setting information when the device sends identification information (an identifier, for example) identifying the information processing apparatus to the another apparatus.

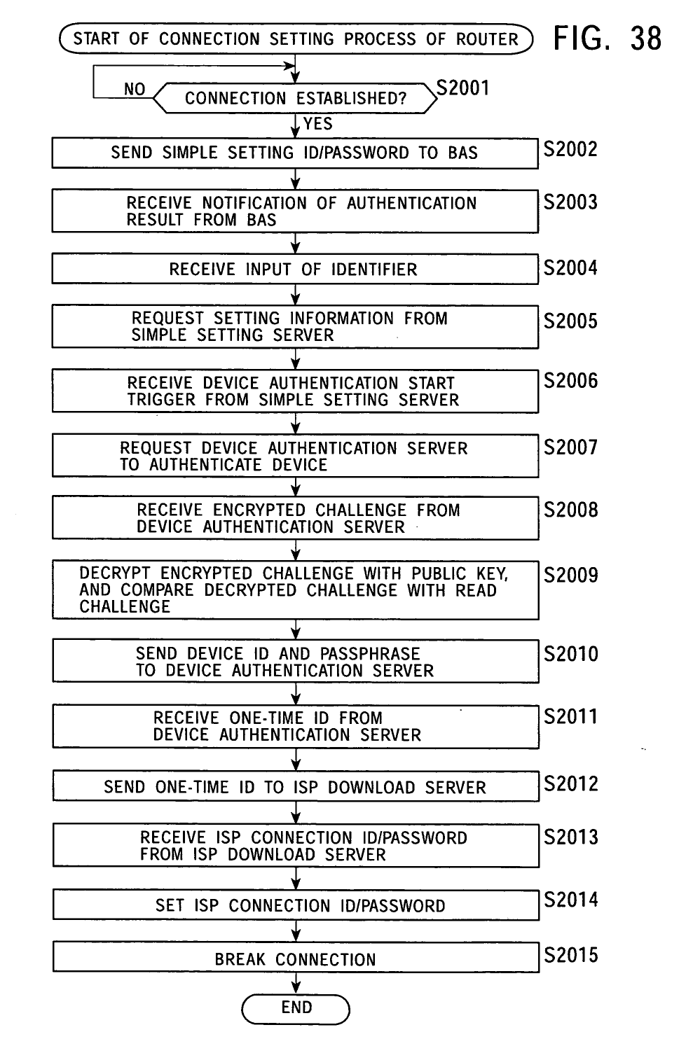

The identification information may be selected from among a plurality of pieces of identification information stored in the device (in step S2004 shown in FIG. 38, for example).

The present invention provides an information processing method by which an information processing apparatus (the ISP download server 44 shown in FIG. 1, for example) provides a device (the router 12 shown in FIG. 1, for example) to be connected to a network with setting information (the ISP connection ID and the password, for example) required to connect to the network. The information processing method includes an authenticating step (step S856 shown in FIG. 34, for example) for authenticating the device based on device identification information (the product code and the serial number) identifying the device, and a sending step (step S857 shown in FIG. 34, for example) for sending the setting information to the authenticated device.

The authenticating step may include acquiring (in step S855 as shown in FIG. 1, for example) the device identification information from another apparatus (the device authentication server 43 shown in FIG. 1, for example) that manages the device identification information and authenticating the device based on the acquired device identification information.

The information processing method may further include a setting information request receiving step (step S851 shown in FIG. 34, for example) for receiving a request for the setting information the device has sent based on determining information identifying the information processing apparatus acquired from another apparatus (the simple setting server 42 shown in FIG. 1, for example) that manages the determining information (the URL of the ISP download server 44 as shown in FIG. 1, for example), wherein the sending step includes sending the setting information to the device from which the request for the setting information is received in the setting information request receiving step.

The setting information request receiving step may include receiving the request for the setting information when the device sends identification information (an identifier, for example) identifying the information processing apparatus to the another apparatus.

The identification information may be selected from among a plurality of pieces of identification information (in step S2004 as shown in FIG. 38, for example) stored in the device.

The present invention provides a computer program for providing a device (the router 12 shown in FIG. 1, for example) to be connected to a network with setting information (the ISP connection ID and the password) required to connect to the network. The computer program includes an authentication control step (step S856 shown in FIG. 34, for example) for controlling the authentication of the device based on device identification information (the product and the serial number) identifying the device, and a sending control step (step S857 shown in FIG. 34, for example) for controlling the sending of the setting information to the authenticated device.

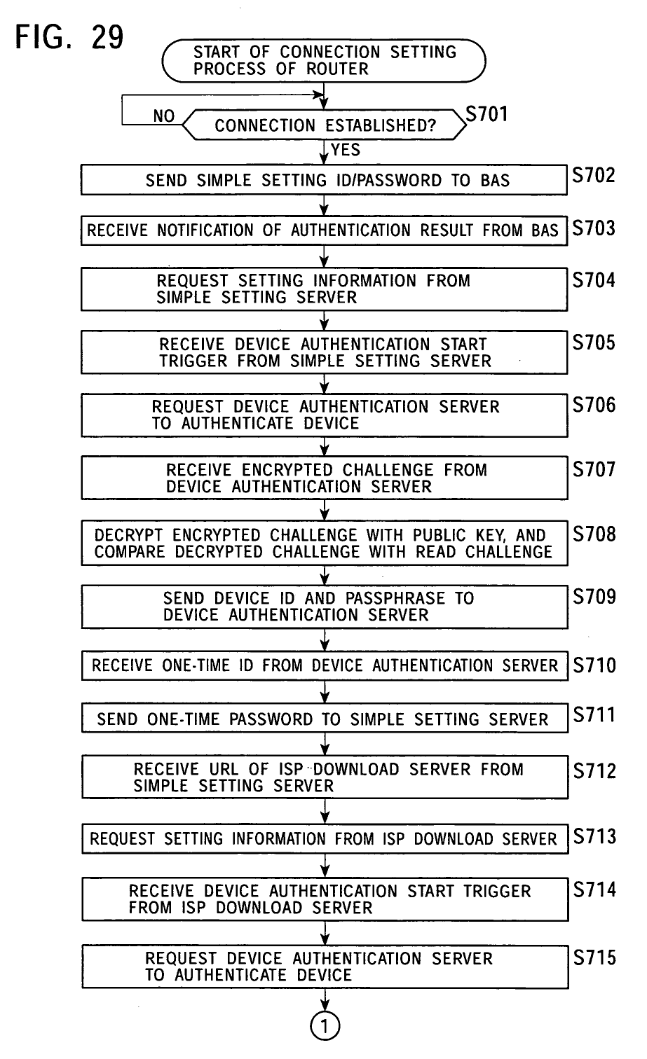

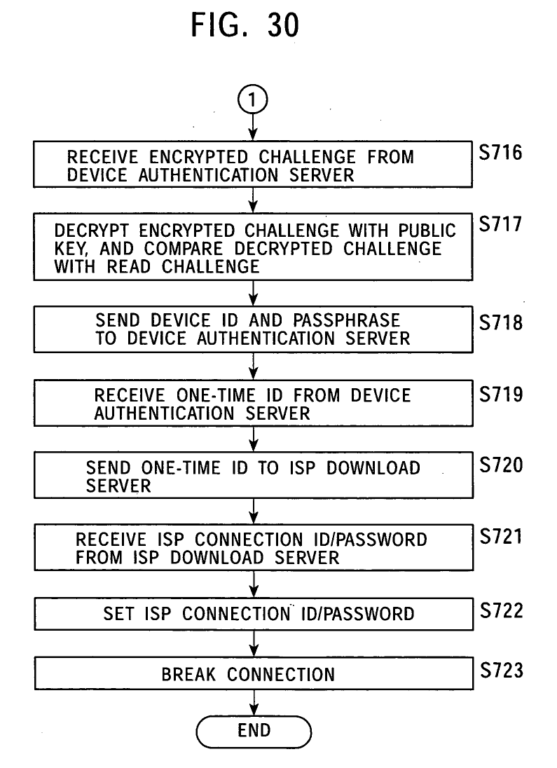

The present invention provides an information processing apparatus (the router 12 shown in FIG. 1) connected to a network. The information processing apparatus includes a receiving unit (the CPU 101 shown in FIG. 2) operable to receive information (the URL, for example) identifying a first apparatus (the ISP download server 44-1 shown in FIG. 1, for example) that manages setting information (the ISP connection ID and the password) required to connect the information processing apparatus to the network, a requesting unit (the CPU 101 shown in FIG. 2 performing a process step in step S715 as shown in FIG. 29) operable to send to a second apparatus (the device authentication server 43 shown in FIG. 1, for example) that is to authenticate the information processing apparatus, identification information (the device ID and the passphrase, for example) identifying the information processing apparatus, and to request the second apparatus to authenticate the information processing apparatus, a sending unit (the CPU 101 shown in FIG. 2 performing a process step in step S720 as shown in FIG. 30, for example) operable to send a result of the authentication by the second apparatus to the first apparatus, and an acquiring unit (the CPU 101 shown in FIG. 2 performing a process step in step S721 as shown in FIG. 30) operable to acquire the setting information from the first apparatus based on the result of the authentication sent by the sending unit.

The information processing apparatus may further include an identifying information requesting unit (the CPU 101 shown in FIG. 2 performing a process step in step S704 as shown in FIG. 29) operable to request the first apparatus identifying information from a third apparatus (the simple setting server 42 shown in FIG. 2, for example) that manages the first apparatus identifying information (the URL of the ISP download server 44, for example), wherein the receiving unit receives the first apparatus identifying information sent by the third apparatus in response to the request from the identifying information requesting unit.

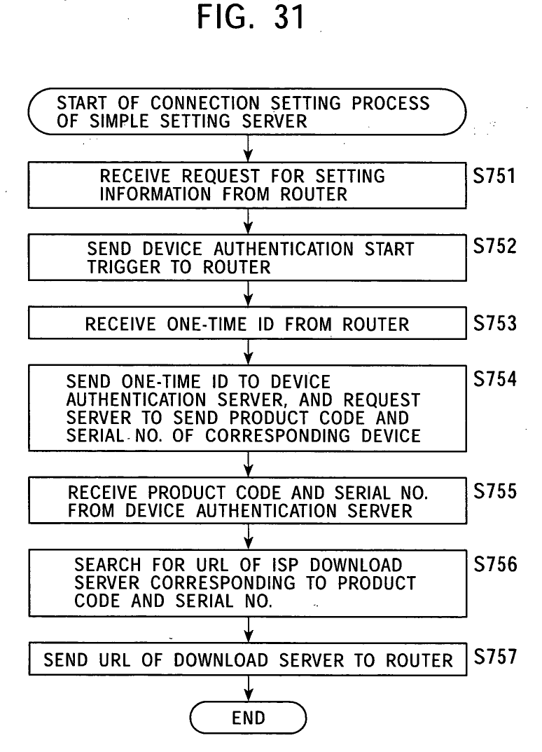

The receiving unit may receive (in step S757 as shown in FIG. 31, for example) the first apparatus identifying information sent by the third apparatus to the information processing apparatus authenticated by the second apparatus.

The identifying information requesting unit may send identification information (the identifier, for example) identifying the first apparatus to the third apparatus and may request the first apparatus identifying information from the third apparatus.

The information processing apparatus may further include a selecting unit (the CPU 101 shown in FIG. 2 performing a process step in step S2004 as shown in FIG. 38) operable to select the identification information identifying the first apparatus from among a plurality of pieces of identification information.

The present invention provides an information processing method for an information processing apparatus (the router 12 shown in FIG. 1, for example) connected to a network. The information processing method includes a receiving step (step S712 shown in FIG. 29, for example) for receiving information (such as the URL) identifying a first apparatus (the ISP download server 44-1 shown in FIG. 1, for example) that manages setting information (the ISP connection ID and the password, for example) required to connect the information processing apparatus to the network, a requesting step (step S715 shown in FIG. 29, for example) for sending, to a second apparatus (the device authentication server 43 shown in FIG. 1) that is to authenticate the information processing apparatus, identification information (the device ID and the passphrase, for example) identifying the information processing apparatus, and for requesting the second apparatus to authenticate the information processing apparatus, a sending step (step S720 shown in FIG. 30, for example) for sending a result of the authentication by the second apparatus to the first apparatus, and an acquiring step (step S721 shown in FIG. 30, for example) for acquiring the setting information from the first apparatus based on the result of the authentication sent in the sending step.

The information processing method may further include an identifying information requesting step (step S704 shown in FIG. 29, for example) for requesting the first apparatus identifying information from a third apparatus (the simple setting server 42 shown in FIG. 1, for example) that manages the first apparatus identifying information (the URL of the ISP download server 44, for example), wherein the receiving step includes receiving the first apparatus identifying information sent by the third apparatus in response to the request for the first apparatus identifying information.

The receiving step may include receiving (in step S757 as shown in FIG. 31, for example) the first apparatus identifying information sent by the third apparatus to the information processing apparatus authenticated by the second apparatus.

The identifying information requesting step may include sending identification information (the identifier, for example) identifying the first apparatus to the third apparatus and requesting the first apparatus identifying information from the third apparatus.

The information processing method may further include a selecting step (step S2004 shown in FIG. 38, for example) for selecting the identification information identifying the first apparatus from among a plurality of pieces of identification information.

The present invention provides a computer program for processing information in an information processing apparatus (the router 12 shown in FIG. 1, for example) connected to a network. The computer program includes a reception control step (step S712 shown in FIG. 29, for example) for controlling the reception of information (the URL, for example) identifying a first apparatus (the ISP download server 44-1 shown in FIG. 1, for example) that manages setting information (the ISP connection ID and the password, for example) required to connect the information processing apparatus to the network, a request control step (step S715 shown in FIG. 29, for example) for controlling the sending of identification information (the device ID and the password, for example) identifying the information processing apparatus to a second apparatus (the device authentication server 43 shown in FIG. 1, for example) that is to authenticate the information processing apparatus, and the requesting of the second apparatus to authenticate the information processing apparatus, a sending control step (step S720 shown in FIG. 30, for example) for controlling the sending of a result of the authentication by the second apparatus to the first apparatus, and an acquisition control step (step S721 shown in FIG. 30, for example) for controlling the acquisition of the setting information from the first apparatus based on the result of the authentication sent in the sending control step.

The embodiments of the present invention are now discussed with reference to the drawings. FIG. 1 is a block diagram generally illustrating an information processing system implementing the present invention.

As shown, an asymmetric digital subscriber line (ADSL) operator network 10 run by an ADSL operator includes a broadband access server (BAS) 31, and a remote authentication dial-in user server (RADIUS) 32.

The BAS 31 causes the RADIUS server 32 to authenticate a router 12 when the BAS 31 receives, from the router 12 owned by a user who has contracted with the ADSL operator, a request to send a piece of setting information, a request for connection to the Internet 15, and a request to send and receive e-mails. The BAS 31 then connects the router 12 to an apparatus responsive to the request from the router 12. The RADIUS server 32 authenticates the router 12 in response to an authentication request from the router 12, and sends the result of the authentication to the BAS 31.

A modem 11, which is managed by the user who has contracted with the ADSL operator, is connected to the BAS 31. The router 12 is connected to the modem 11. At least one device, including a personal computer or a CE device, is connected to the router 12. In response to the request for connection to the Internet 15 and the request to send or the request to receive the e-mail from the connected personal computer and the CE device, the router 12 sends such a request to the BAS 31 through the modem 11. In response to the receipt of information such as hyper text markup language (HTML), the router 12 supplies the requesting personal computer or CE device with the information.

The setting of the information in the router 12 to connect the router 12 to the Internet 15 (the setting information for point-to-point protocol over an Ethernet® (PPPoE) connection of the router 12) will now be described. Referring to FIG. 1, a single modem 11 and a single router 12 are used. In practice, however, a plurality of modems and a plurality of routers respectively managed by a plurality of users who have contracted with the ADSL operator may be connected in the system.

A router 41 is connected to the BAS 31. A local area network (LAN) 13 is formed of the router 41, and a simple setting server 42, a device authentication server 43, and ISP download servers 44-1 through 44-n, each connected to the router 41. The router 41 exchanges communications between the simple setting server 42, the device authentication server 43, and the ISP (Internal Service Provide) download servers 44-1 through 44-n while exchanging communications between the router 12 and each of the simple setting server 42, the device authentication server 43, and the ISP (Internal Service Provide) download servers 44-1 through 44-n at the same time. In the discussion that follows, the ISP download servers 44-1 through 44-n are collectively referred to as the ISP download server 44 if there is no particular need for distinguishing between the ISP download servers 44-1 through 44-n (the same is true of other elements).

Upon receiving an access from an apparatus (the router 12, for example) requesting setting information, the simple setting server 42 sends a device authentication start trigger (to be discussed later in detail) to the requesting apparatus. The device authentication server 43 generates a challenge public key and a challenge private key, and causes a storage 308 (see FIG. 6) to store the challenge public key and the challenge private key in association with each other. The device authentication server 43 sends the challenge public key to a factory server 61.

The ISP download server 44-1 holds the setting information that is required to connect, through the ISP server 51-1 to the Internet 15, a device owned by a user who has contracted with the ISP 14. The ISP download server 44-1 sends the setting information to the router 12 owned by the user who has contracted with the ISP 14-1. The ISP download server 44-2 holds the setting information that is required to connect, through the ISP server 51-2 to the Internet 15, a device owned by a user who has contracted with an ISP 14-2. The ISP download server 44-2 sends the setting information to the router owned by the user who has contracted with the ISP 14-2. The ISP download server 44-n (n is a natural number) holds the setting information that is required to connect, through an ISP server 51-n to the Internet 15, a device owned by a user who has contracted with an ISP 14-n. The ISP download server 44-n sends the setting information to a router owned by the user who has contracted with the ISP 14-n.

Also connected to the BAS 31 are ISP server 51-1 through the ISP server 51-n respectively managed by the ISP 14-1 through the ISP 14-n as Internet connection providers. The ISP server 51-1 connects the device owned by the user who has contracted with the ISP 14 to the Internet 15. The ISP server 51-2 connects the device owned by the user who has contracted with the ISP 14-2 to the Internet 15. The ISP server 51-n connects the device owned by the user who has contracted with the ISP 14-n to the Internet 15.

A factory server 61 installed in a factory 16 that manufactures the router 12 is connected to the Internet 15. The factory server 61 manages a device ID, a passphrase, a product code, and a serial number (each will be discussed later) of the router 12 manufactured in the factory 16, and sends these pieces of information to the device authentication server 43 as necessary. The factory server 61 receives the challenge public key from the device authentication server 43 and records the challenge public key on the manufactured router 12.

FIG. 2 is a block diagram illustrating the structure of the router 12. As shown, the CPU 101 performs a variety of processes in accordance with a program stored in a ROM 102 and a program that is loaded to a RAM 103 from a storage 108. The RAM 103 stores data the CPU 101 requires to perform the variety of processes.

The CPU 101, the ROM 102, and the RAM 103 are mutually connected through a bus 104. The bus 104 is connected to an input/output interface 105.

Connected to the input/output interface 105 are an operation unit 106 including buttons and switches, an indicator 107 including a light emitting diode (LED), a storage 108 including a hard disk, a local-area network (LAN) communication unit 109 for controlling communications with the personal computer or the CE device owned by the user, and a wide-area network (WAN) communication unit 110 for controlling communications with the BAS 31 through the modem 11.

Also connected to the input/output interface 105 is a drive 111 as necessary. A magnetic disk 121, an optical disk 122, a magneto-optical disk 123 and a semiconductor memory 124 are loaded into the drive 111, and a computer program read therefrom is installed into the storage 108 as necessary.

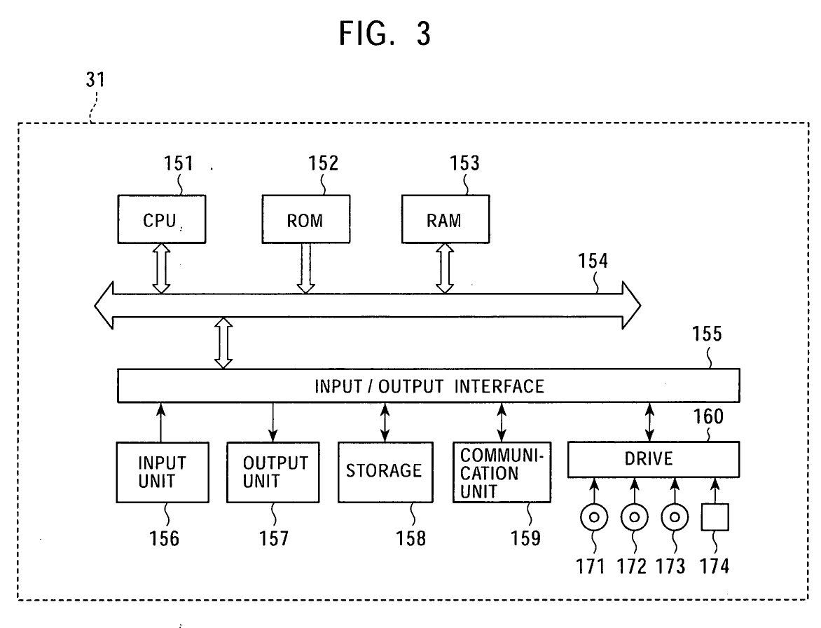

FIG. 3 is a block diagram illustrating the structure of the broadband access server (BAS) 31. As shown, a CPU 151 performs a variety of processes in accordance with a program stored in the ROM 152, and a program loaded from the storage 158 to the RAM 153. The RAM 153 also stores data the CPU 151 requires to perform the variety of processes.

The CPU 151, the ROM 152, and the RAM 153 are mutually connected through a bus 154. The bus 154 is connected to an input/output interface 155.

Also connected to the input/output interface 155 are an input unit 156 including a keyboard and a mouse, an output unit 157 including a display such as a cathode ray tube (CRT) or a liquid-crystal display (LCD), and a loudspeaker, a storage 158 including a hard disk, and a communication unit 159 including a modem and a terminal adaptor. The communication unit 159 performs a communication process through networks including the Internet 15.

Also connected to the input/output interface 155 as necessary is a drive 160. A magnetic disk 171, an optical disk 172, a magneto-optical disk 173 and a semiconductor memory 174 are loaded into the drive 160 as necessary. A computer program read therefrom is installed into the storage 158.

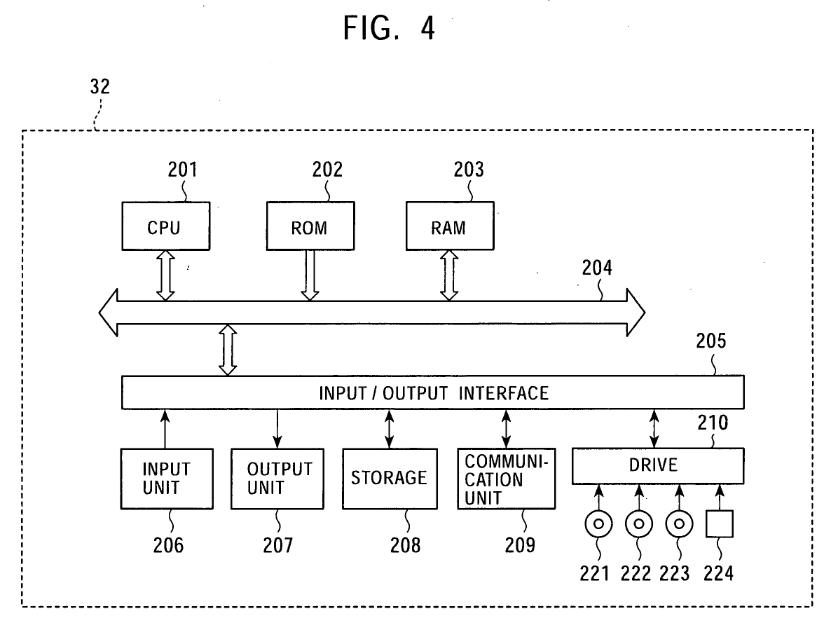

FIG. 4 is a block diagram illustrating the structure of the RADIUS server 32. The components of the RADIUS server 32 from a CPU 201 through a semiconductor memory 224 are respectively identical in structure to the components of the BAS 31 shown in FIG. 3 from the CPU 151 through the semiconductor memory 174. Since the identical elements have the same functions, a discussion thereof is omitted here.

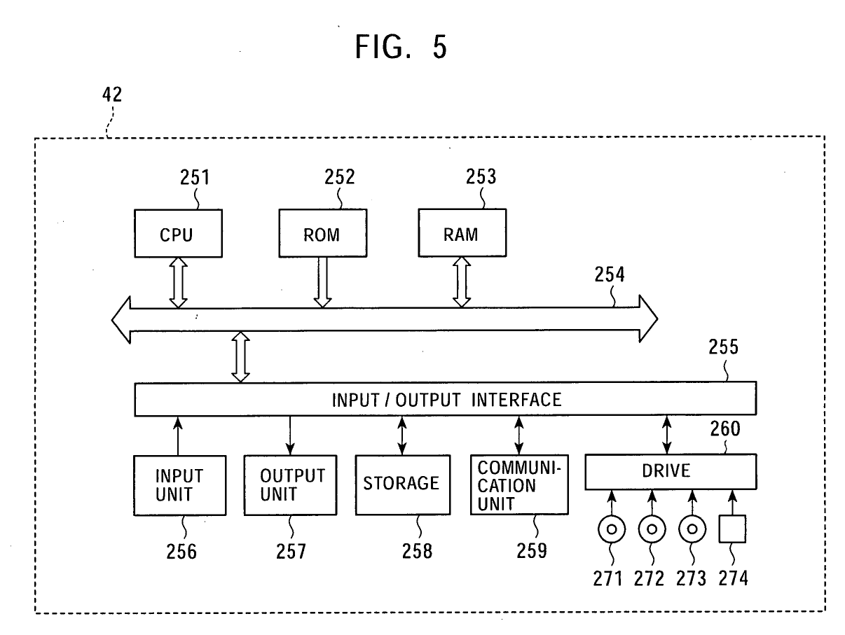

FIG. 5 is a block diagram illustrating the structure of the simple setting server 42. The components of the simple setting server 42 from a CPU 251 through a semiconductor memory 274 are respectively identical in structure to the components of the BAS 31 shown in FIG. 3 from the CPU 151 through the semiconductor memory 174. Since the identical elements have the same functions, a discussion thereof is omitted here.

FIG. 6 is a block diagram illustrating the structure of the device authentication server 43. The components of the device authentication server 43 from a CPU 301 through a semiconductor memory 324 are respectively identical in structure to the components of the BAS 31 shown in FIG. 3 from the CPU 151 through the semiconductor memory 174. Since the identical elements have the same functions, a discussion thereof is omitted here.

FIG. 7 is a block diagram illustrating the structure of the ISP download server 44-1. The components of the ISP download server 44-1 from a CPU 351 through a semiconductor memory 374 are respectively identical in structure to the components of the BAS 31 shown in FIG. 3 from the CPU 151 through the semiconductor memory 174. Since the identical elements have the same functions, a discussion thereof is omitted here. The ISP download servers 44-2 through 44-n are basically identical in structure to the ISP download server 44-1.

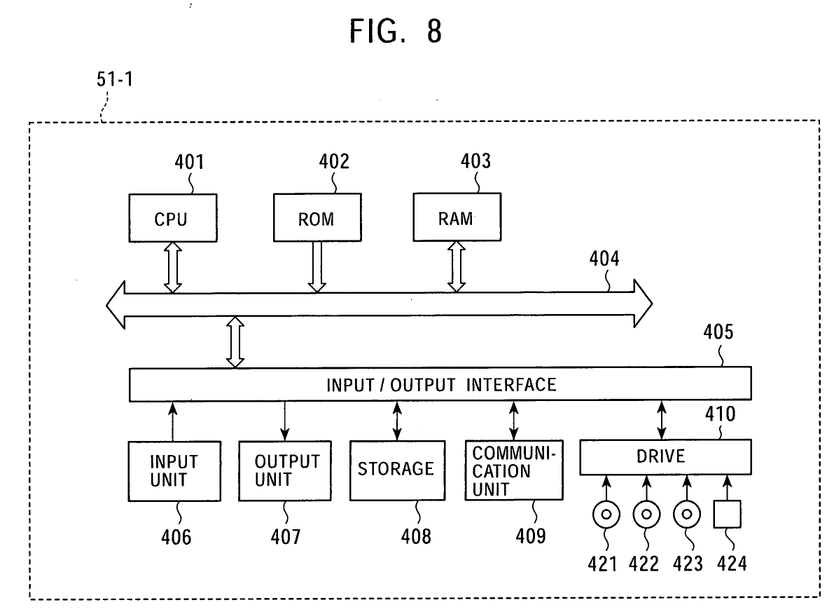

FIG. 8 is a block diagram illustrating the structure of the ISP server 51-1. The components of the ISP server 51-1 from a CPU 401 through a semiconductor memory 424 are respectively identical in structure to the components of the BAS 31 shown in FIG. 3 from the CPU 151 through the semiconductor memory 174. Since the identical elements have the same functions, a discussion thereof is omitted here. The ISP servers 51-2 through 51-n are identical in structure to the ISP server 51-1.

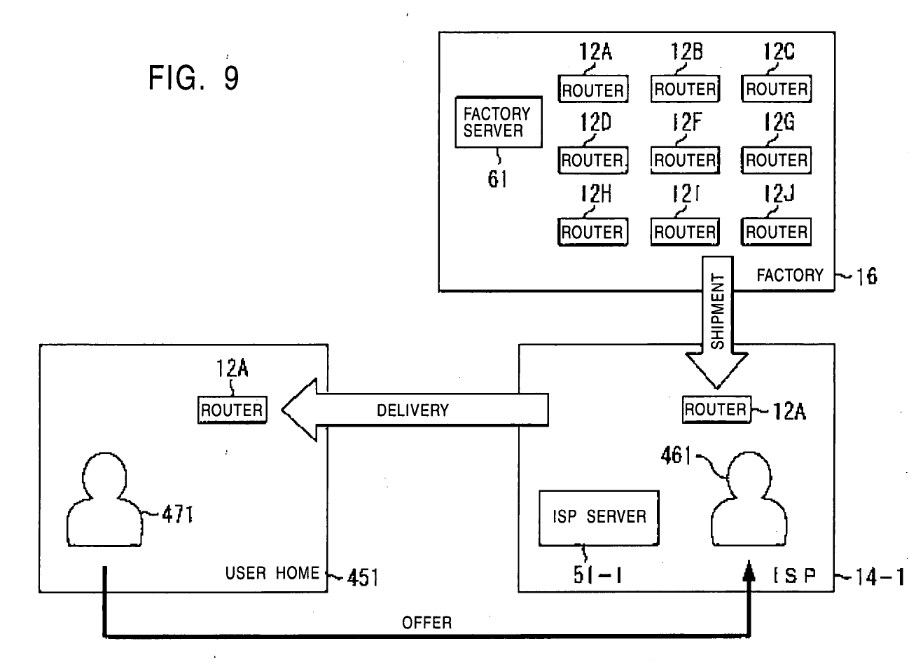

A process starting with the manufacture of the router 12 via a step in which a user, who has not yet contracted, contracts with an ISP 14 to a step in which the router 12 is connected to the Internet 15 is discussed with reference to FIG. 9.

As shown in FIG. 9, the routers 12A through 12J are manufactured in the factory 16 and then shipped to the ISP 14-1. In other words, the routers 12A through 12J are assembled in the factory 16. The factory server 61 installed in the factory 16 generates a simple setting ID, a password, a product registration number, a product ID, and a passphrase, required to be authenticated by the RADIUS server 32. Since the device authentication server 43 sends a challenge public key to the factory server 61, the factory server 61 receives and temporarily stores the challenge public key. The ROM 102 of each of the routers 12A through 12J stores the simple setting ID, the password, the device ID, the passphrase generated by the factory 16, and a uniform resource locator (URL) for connection to the simple setting server 42 while also storing the challenge public key received from the device authentication server 43. The device ID is identification information identifying each of the devices (the routers 12A-12J), and the passphrase is a random number the user cannot decrypt.

The factory server 61 also generates a product registration number, a product code, and a serial number unique to each router 12, and attaches the product registration number to the router 12. The routers 12A-12J shipped from the factory 16 are tagged with the respective product registration numbers. The product registration numbers uniquely identify the manufactured routers 12A-12J. The product code and the serial number are determined by performing a predetermined calculation based on the product registration number (the product registration number corresponds to the product code and the serial number in one-to-one correspondence). Alternatively, the product code and the serial number are searched for in a database with the product registration number used as a key. The product code and the serial number are unique to each router 12, and there are no other routers having the same product code and the same serial number. The product registration number may be labeled on each of the routers 12A-12J. A label bearing the product registration number may be attached to the respective packing box containing the respective router, or may be simply packed together with the respective router in the packing box.

As described above, the factory 16 generates the product ID, the passphrase, the product registration number, the product code, and the serial number unique to each of the manufactured routers 12A-12J. The product ID, the passphrase, the product code, and the serial number are sent from the factory server 61 installed in the factory 16 to the device authentication server 43, and are then stored in association with each other in the storage 308 in the device authentication server 43. Upon acquiring the product ID and the passphrase, the device authentication server 43 determines the product code and the serial number, which are stored in association with the acquired product ID and passphrase.

For the convenience of explanation, FIG. 9 simply shows the nine routers 12A-12J. In practice, routers of more than the nine shown in FIG. 9 are manufactured. The internal structure of each of the routers 12A-12J is identical to the one already shown in FIG. 2.

An operator 461 of the ISP 14 accepts a subscription application for the ISP 14 and a purchase order for a router from the user via communication means such as mail or telephone. The user 471 informs the operator 461 of the registration information including the name of the user, the credit card number, and the address of the user when the subscription application and the purchase order are placed.

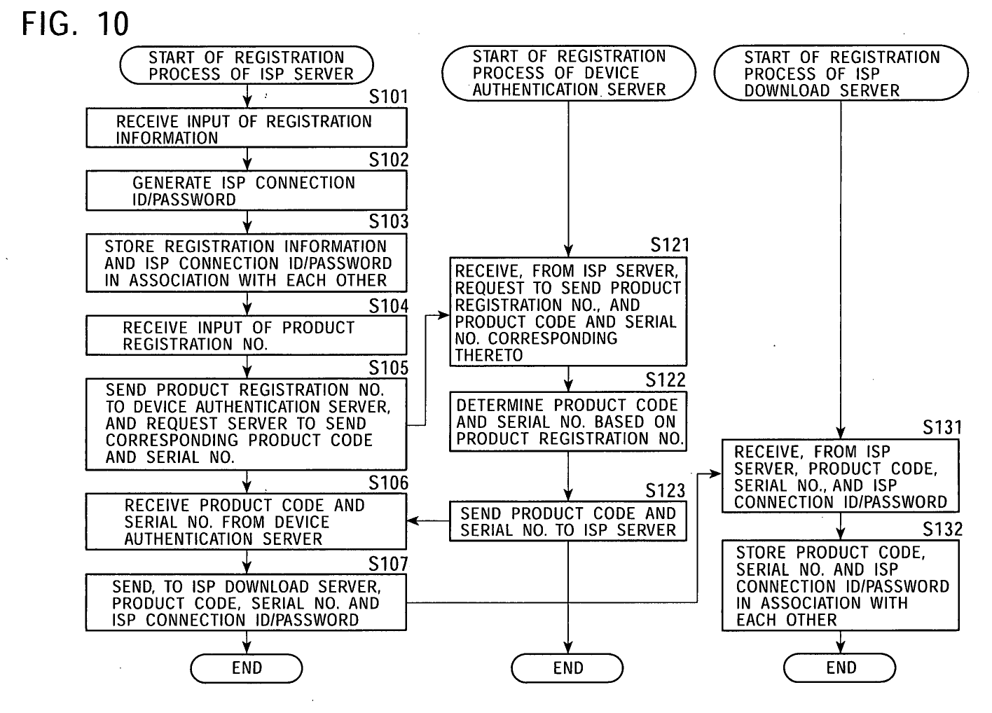

In accordance with the user name and the credit card number, the operator 461 checks with a credit card company that the user 471 is a registered member of that credit company. After confirming that the user 471 is a registered member of the credit card company, and that no error is contained in the user name and the credit card number, the operator 461 inputs, to the ISP server 51-1, the registration information informed by the user 471 and the product registration number of the router (the router 12A, for example) to be delivered to the user 471, and then registers the user 471 as a member of the ISP 14-1. Details of the process for registering the user 471 as a member of the ISP 14-1 will be discussed later with reference to the flowchart shown in FIG. 10. Through the registration process, the user 471 has contracted with the ISP 14.

The router 12A is delivered to the user home 451 from the ISP 14-1 when the user 471 has contracted with the ISP 14-1. The delivery destination of the router 12A is not limited to the user home 451, and may be any address desired by the user 471. However, the user 471 cannot install and use the router 12A outside the service area of the ADSL operator network 10.

The user 471 connects the delivered router 12A to the modem 11 as shown in FIG. 1. A connection setting process is now automatically performed as will be discussed later, and various information is thus set in the router 12A. Without inputting the setting information to the router 12A, the user 471 is now able to monitor WEB pages on the Internet 15 after connecting a personal computer or a CE device to the router 12A.

With reference to the flowchart shown in FIG. 10, the process for registering the user 471 as a member of the ISP 14-1 will now be described.

In step S101 shown in FIG. 10, the CPU 401 of the ISP server 51-1 receives the registration information containing the user name and the credit card number from the operator 461 through the input unit 406, and temporarily stores the registration information in the RAM 403.

In step S102, the CPU 401 of the ISP server 51-1 generates and temporarily stores an ISP connection ID and a password in the RAM 403. The ISP connection ID and the password are the setting information required for the router 12 to access the Internet 15 through the ISP server 51-1.

In step S103, the CPU 401 of the ISP server 51-1 stores, in the storage 408, the registration information received in step S101 and the ISP connection ID and the password generated in step S102 in association with the registration information. The storage 408 stores the registration information, the ISP connection ID and the password in association with each other by the user who has contracted with the ISP 14-1.

The operator 461 inputs the product registration number attached to the router 12A delivered to the user 471. In step S104, the CPU 401 of the ISP server 51-1 receives the input of the product registration number from the operator 461 through the input unit 406, and temporarily stores the product registration number in the RAM 403.

In step S105, the CPU 401 of the ISP server 51-1 sends, to the device authentication server 43 through the communication unit 409, the product registration number stored in the RAM 403 in step S104, and requests the device authentication server 43 to send the product code and the serial number corresponding to the product registration number.

In step S121, the CPU 301 of the device authentication server 43 receives, through the communication unit 309, the production registration number and the request to send the product code and the serial number sent by the ISP server 51-1.

In step S122, the CPU 301 of the device authentication server 43 determines the product code and the serial number based on the product registration number received in step S121. More specifically, the product code and the serial number are determined by performing a predetermined calculation based on the product registration number as already discussed (alternatively, the product code and the serial number are searched for in the database using the product registration number as a key). The CPU 301 of the device authentication server 43 determines the product code and the serial number by performing the predetermined calculation. In step S123, the CPU 301 of the device authentication server 43 sends, to the ISP server 51-1 through the communication unit 309, the product code and the serial number determined in step S122.

In step S106, the CPU 401 of the ISP server 51-1 receives, through the communication unit 409, the product code and the serial number sent by the device authentication server 43 in step S123, and temporarily stores the product code and the serial number in the RAM 403.

In step S107, the CPU 401 of the ISP server 51-1 reads, from the RAM 403, the ISP connection ID and the password generated in step S102, and the product code and the serial number received in step S106, and sends these pieces of information to the ISP download server 44-1 through the communication unit 409.

In step S131, the ISP download server 44-1 receives, through the communication unit 359, the ISP connection ID, the password, the product code and the serial number sent by the ISP server 51-1 in step S107, and stores, in the storage 358 in step S132, the ISP connection ID, the password, the product code and the serial number received in step S131.

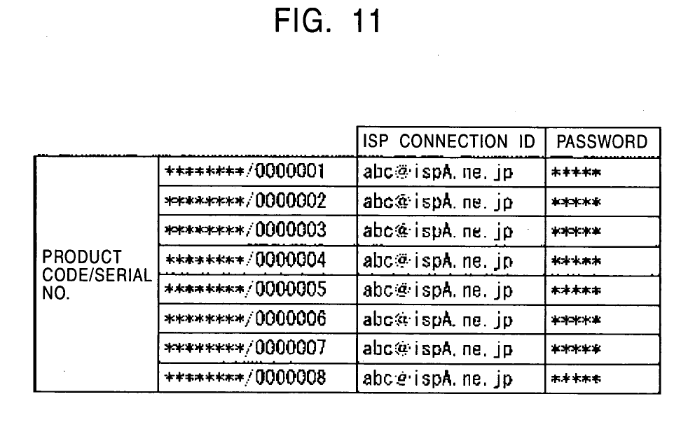

FIG. 11 illustrates the ISP connection ID, the password, the product code and the serial number stored in this way in the storage 358 of the ISP download server 44-1. The table in FIG. 11 lists the ISP connection ID and the password corresponding to each of a plurality of product codes and serial numbers. As shown, all product codes and serial numbers are listed in a format of “********/0000001” with each code and each serial number separated by a slash (/) delimiter. The product code uses eight digit numbers. Serial numbers are seven digit serial numbers like “0000001”, “0000002”, “0000003”, “0000004”, “0000005”, “0000006”, and “0000007” as listed from top to bottom in FIG. 11. Each of the product code and the serial number are not duplicated so that one product code and one serial number are respectively identifiable from the other product codes and the other serial numbers.

As shown in FIG. 11, the ISP connection ID and the password stored in association with the product code and the serial number are the setting information. As will be discussed later, if the ISP connection ID and the password are set in the router 12, that router 12 becomes connectable with the ISP server 51.

Referring to FIG. 11, all ISP connection IDs are “abc@ispA.ne.jp”. In practice, all ISP connection IDs are not always the same. The passwords are “*****” in FIG. 11, but are not limited to five digit numbers.

The registration process is performed in this way. In the above discussion, the registration process is performed on the ISP 14-1. The registration process remains unchanged even if the registration process is performed on each of the ISPs 14-2 through 14-n.

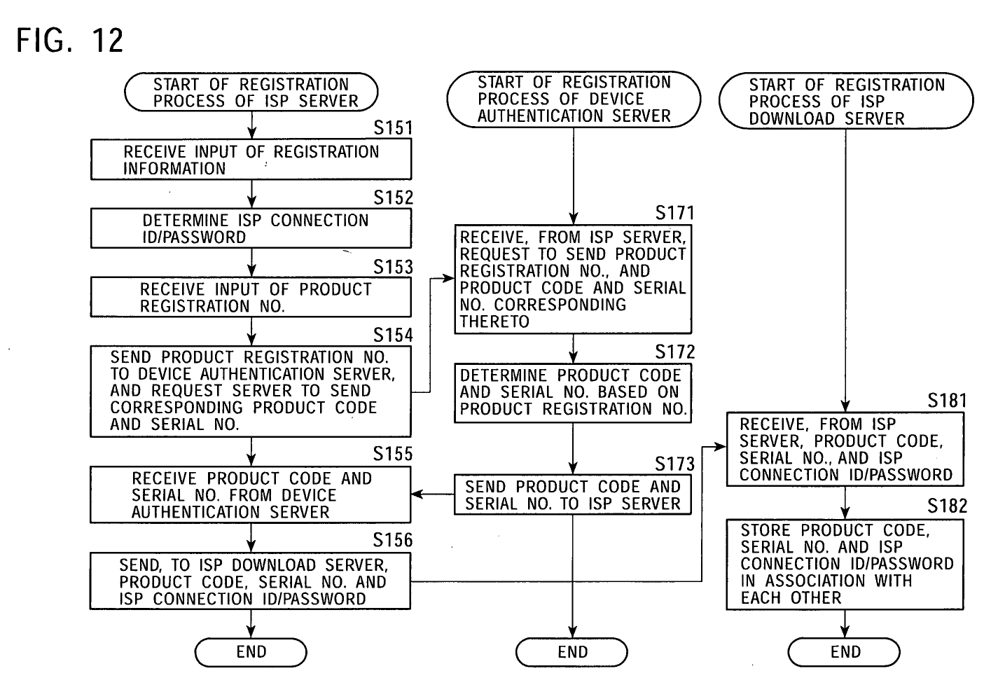

In the above discussion, the registration process is performed for a user who was uncontracted with the ISP 14-1. Another registration process of the router 12 will now be described with reference to the flowchart shown in FIG. 12. In this registration process, a user who has already contracted with the ISP 14-1 newly purchases a router 12. The process illustrated in the flowchart shown in FIG. 12 remains unchanged from the process illustrated in the flowchart shown in FIG. 10 except for the process in step S152.

Upon being informed of the registration information from the user 471, the operator 461 of the ISP 14-1 inputs the registration information to the ISP server 51-1. When the CPU 401 of the ISP server 51-1 receives the input of the registration information in step S151 shown in FIG. 12, the CPU 401 of the ISP server 51-1 determines, in step S152, the same registration information as the one already stored in the storage 408 in response to the registration information input in step S151. The CPU 401 of the ISP server 51-1 determines the ISP connection ID and the password stored in association with the registration information.

The processes in steps S153 through S156, respectively, remain identical to the processes in steps S104 through S107 shown in FIG. 10, and a discussion thereof is omitted here. The processes in steps S171 through S173, and in steps S181 and S182 shown in FIG. 12 are identical to the processes in steps S121 through S123 and steps S131 and S132 shown in FIG. 12, respectively, and a discussion thereof is omitted here.

This registration process is thus performed if the user has already contracted with the ISP 14-1.

As already discussed, the router 12 is delivered to the user home 451 subsequent to the registration process. The user 471 connects the delivered router 12 to the modem 11. Upon connecting the router 12, the connection setting process automatically starts.

The connection setting process will now be described in detail with reference to the flowcharts shown in FIGS. 13 through 18. In this connection setting process, the router 12 of the user 471 who has contracted with the ISP 14-1 is set for connection to the ISP server 51-1.

When the router 12 is switched on, the CPU 101 of the router 12 monitors the WAN communication unit 110 in step S201 shown in FIG. 13, and waits on standby until the WAN communication unit 110 is connected to the modem 11 through a predetermined cable. When the WAN communication unit 110 is connected to the modem 11 using the predetermined cable, the process proceeds to step S202.

In step S202, the CPU 101 of the router 12 reads the simple setting ID and the password stored in the ROM 102 when the router 12 was manufactured in the factory 16, and then sends the simple setting ID and the password to the BAS 31 through the WAN communication unit 110.

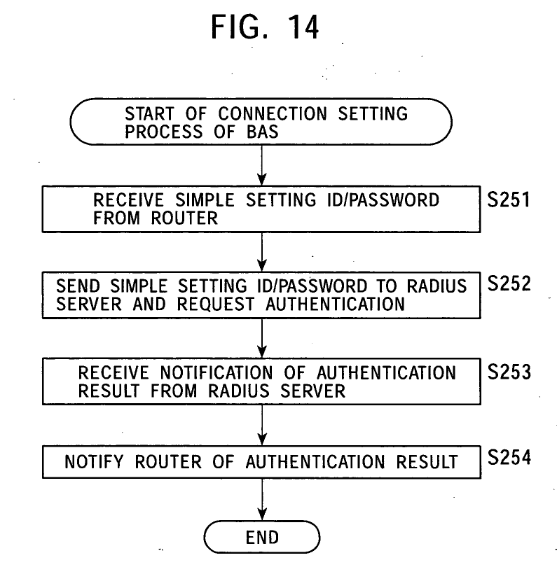

In step S251 shown in FIG. 14, the CPU 151 of the BAS 31 receives, through the communication unit 159, the simple setting ID and the password, which have been sent by the router 12 in step S202. In step S252, the CPU 151 of the BAS 31 sends, to the RADIUS server 32 through the communication unit 159, the simple setting ID and the password, which have been received in step S251, and then requests the RADIUS server 32 to authenticate the router 12.

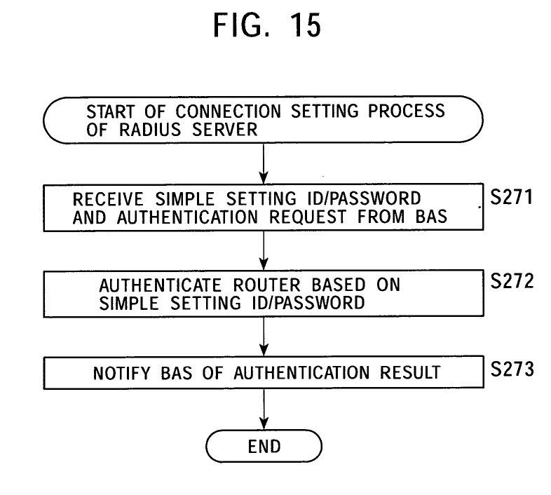

In step S271 shown in FIG. 15, the CPU 201 of the RADIUS server 32 receives, through the communication unit 209, the simple setting ID and the password and the request to authenticate the router 12, sent by the BAS 31 in step S252. In step S272, the CPU 201 of the RADIUS server 32 authenticates the router 12 based on the simple setting ID and the password received in step S271. More specifically, the RADIUS server 32 stores beforehand the simple setting ID and the password in the storage 208, and authenticates the router 12 by determining whether the simple setting ID and the password, received in step S271, match the simple setting ID and the password stored in the storage 208.

If the simple setting ID and the password received in step S271 match the simple setting ID and the password stored in the storage 208, the router 12 is permitted to access, through the BAS 31, the simple setting server 42, the device authentication server 43, the ISP download servers 44-1 through 44-n, and the ISPs 14-1 through 14-n. If the simple setting ID and the password received in step S271 fail to match the simple setting ID and the password stored in the storage 208, the router 12 is not permitted to access, through the BAS 31, the simple setting server 42, the device authentication server 43, the ISP download servers 44-1 through 44-n, and the ISPs 14-1 through 14-n.

In step S273, the CPU 201 of the RADIUS server 32 notifies the BAS 31 through the communication unit 209 of the authentication result obtained in step S272 (whether or not the router 12 is permitted to access, through the BAS 31, the simple setting server 42, the device authentication server 43, the ISP download servers 44-1 through 44-n, and the ISPs 14-1 through 14-n).

In step S253 shown in FIG. 14, the CPU 151 of the BAS 31 receives the authentication result sent by the RADIUS server 32 in step S273. In step S254, the CPU 151 of the BAS 31 informs the router 12 of the authentication result through the communication unit 159.

In step S203 shown in FIG. 13, the CPU 101 of the router 12 receives, through the WAN communication unit 110, the authentication result that is sent by the BAS 31 in step S254. If the authentication result indicates that the router 12 is permitted to access, through the BAS 31, the simple setting server 42, the device authentication server 43, the ISP download servers 44-1 through 44-n, and the ISPs 14-1 through 14-n, the process proceeds to step S204. Thereafter, the router 12 is granted a right to access, through the BAS 31, the simple setting server 42, the device authentication server 43, the ISP download servers 44-1 through 44-n, and the ISPs 14-1 through 14-n.

If the authentication result indicates that the router 12 is not permitted to access, through the BAS 31, the simple setting server 42, the device authentication server 43, the ISP download servers 44-1 through 44-n, and the ISPs 14-1 through 14-n, the CPU 101 of the router 12 causes a predetermined LED of the indicator 107 to light (or to blink), thereby alerting the user 471 to an error in the connection setting process. If the router 12 accesses the BAS 31 later, the RADIUS server 32 performs the authentication process again.

In step S204, the CPU 101 of the router 12 reads the URL that is used for access to the simple setting server 42 which was stored in the ROM 102 when the router 12 was manufactured, accesses the URL (of the simple setting server 42) through the WAN communication unit 110, and requests the simple setting server 42 to send the setting information.

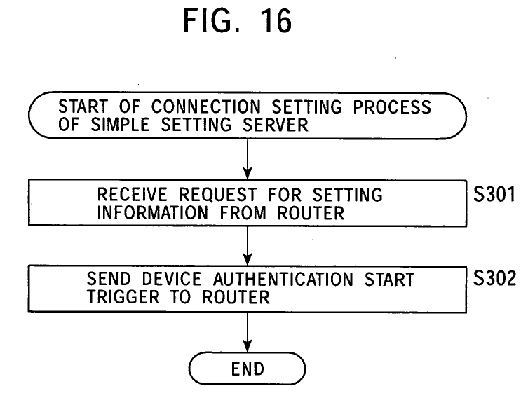

In step S301 shown in FIG. 16, the CPU 251 of the simple setting server 42 receives, through the communication unit 259, the request to send the setting information that has been sent by the router 12 in step S204.

The simple setting server 42 stores beforehand in a storage 258 a device authentication start trigger that requests the start of the process for authenticating the device (the router 12). The device authentication start trigger is an HTML containing the URL of the device authentication server 43 performing the device authentication, and the URL of the ISP download server 44 holding the setting information (such as the ISP connection ID and the password). In step S302, the CPU 251 of the simple setting server 42 reads the device authentication start trigger from the storage 258, and sends the device authentication start trigger to the router 12 through the communication unit 259.

In step S205 shown in FIG. 13, the CPU 101 of the router 12 receives, through the WAN communication unit 110, the device authentication start trigger that has been sent by the simple setting server 42 in step S302, and temporarily stores the device authentication start trigger in the RAM 103.

In step S206, the CPU 101 of the router 12 generates a random number (the random number generated in step S206 is hereinafter referred to as a challenge). The CPU 101 of the router 12 sends the challenge to the device authentication server 43 through the WAN communication unit 110 while requesting the device authentication server 43 to authenticate the router 12. The router 12 sends the challenge to the device authentication server 43 by accessing the URL of the device authentication server 43 contained in the device authentication start trigger. The CPU 101 of the router 12 temporarily stores the generated challenge in the RAM 103.

In step S321 shown in FIG. 17, the CPU 301 of the device authentication server 43 receives, through the communication unit 309, the challenge and the request for device authentication sent by the router 12 in step S206. As already discussed, the device authentication server 43 stores the challenge public key and the challenge private key in association with each other in the storage 308. In step S322, the CPU 301 of the device authentication server 43 reads the challenge private key from the storage 308, and encrypts the challenge received in step S321 with the challenge private key. In step S323, the CPU 301 of the device authentication server 43 sends the challenge encrypted in step S322 to the router 12 through the communication unit 309.

In step S207 shown in FIG. 13, the CPU 101 of the router 12 receives, through the WAN communication unit 110, the encrypted challenge sent by the device authentication server 43 in step S323. As already discussed, the ROM 102 of the router 12 has already stored the challenge public key when the router 12 was manufactured in the factory 16. In step S208, the CPU 101 of the router 12 reads the challenge public key from the ROM 102, and decrypts the encrypted challenge with the challenge public key. The CPU 101 of the router 12 reads the challenge generated in step S206 from the RAM 103, and compares the read challenge with the decrypted challenge. If the challenge generated in step S206 matches the decrypted challenge, the CPU 101 of the router 12 determines that the device authentication server 43 is a correct server as an access destination, and then proceeds to step S209.

In step S209, the CPU 101 of the router 12 reads the device ID and the passphrase from the ROM 102, and then sends the device ID and the passphrase to the device authentication server 43 through the WAN communication unit 110. In this case, the router 12 sends the device ID and the passphrase with the URL thereof attached thereto to the device authentication server 43.

In step S324 shown in FIG. 17, the CPU 301 of the device authentication server 43 receives, through the communication unit 309, the device ID and the passphrase which have been sent by the router 12 in step S209. The device authentication server 43 stores beforehand, in the storage 308, the device ID, the passphrase, the product code, and the serial number, received from the factory server 61. In step S325, the CPU 301 of the device authentication server 43 determines whether the device ID and the passphrase, received in step S324, are found among the device IDs and the passphrases stored in the storage 308. If the device ID and the passphrase, received in step S324, are found among the device IDs and the passphrases stored in the storage 308, the CPU 301 of the device authentication server 43 authenticates the router 12 as a device manufactured in the factory 16, and then the process proceeds to step S326.

If the device ID and the passphrase, received in step S324, are not found among the device IDs and the passphrases stored in the storage 308, the CPU 301 of the device authentication server 43 determines that the router 12 is not a device shipped from the factory 16, and reports a device authentication error to the router 12. In response to the device authentication error, the router 12 causes the indicator 107 to light (or to blink).

In step S326, the CPU 301 of the device authentication server 43 generates a one-time ID that is valid one time only, and stores the generated one-time ID in association with the device ID, the passphrase, the product code and the serial number in the storage 308. The one-time ID, valid one time only, is generated as a result of device authentication. The one-time ID is identification information used to determine the corresponding product code and serial number of the router in steps S328 and S329 to be discussed later. The one-time ID contains no information relating to the devices constituting the present system such as the router 12 and the device authentication server 43. Even if the one-time ID is known to a third party, no information is extracted from the one-time ID.

In step S327, the CPU 301 of the device authentication server 43 sends the one-time ID generated in step S326 to the router 12 through the communication unit 309. In this case, the device authentication server 43 sends the one-time ID to the URL of the router 12 attached to the device ID and the passphrase received in step S324.

In step S210 shown in FIG. 13, the CPU 101 of the router 12 receives, through the WAN communication unit 110, the one-time ID sent by the device authentication server 43 in step S327. In step S211, the CPU 101 of the router 12 sends the one-time ID received in step S210 to the ISP download server 44-1 through the WAN communication unit 110. In this case, the router 12 sends the one-time ID to the ISP download server 44-1 by accessing the URL of the ISP download server 44-1 contained in the device authentication start trigger (stored in the RAM 103 in step S205).

In step S351 shown in FIG. 18, the CPU 351 of the ISP download server 44-1 receives, through the communication unit 359, the one-time ID that has been sent by the router 12 in step S211. In step S352, the CPU 351 of the ISP download server 44-1 sends, through the communication unit 359, the one-time ID received in step S351 to the device authentication server 43, and requests the device authentication server 43 to send the product code and the serial number corresponding to the one-time ID.

In step S328 shown in FIG. 17, the CPU 301 of the device authentication server 43 receives, through the communication unit 309, the one-time ID and the request to send the product code and the serial number corresponding to the one-time ID, sent by the ISP download server 44-1 in step S352. The device authentication server 43 has already stored the one-time ID in association with the device ID, the passphrase, the product code and the serial number in step S326. In step S329, the CPU 301 of the device authentication server 43 finds the one-time ID identical to the one-time ID received in step S328 from among the one-time IDs stored in the storage 308, and reads the product code and the serial number corresponding to the found one-time ID from the storage 308. The CPU 301 of the device authentication server 43 sends the read product code and the read serial number to the ISP download server 44-1 through the communication unit 309.

In step S353 shown in FIG. 18, the CPU 351 of the ISP download server 44-1 receives, through the communication unit 359, the product code and the serial number sent by the device authentication server 43 in step S329. In step S132 shown in FIG. 10, the ISP download server 44-1 has already stored the product code, the serial number, the ISP connection ID, and the password in association with each other in the storage 358 (see FIG. 11). In step S354 shown in FIG. 18, the CPU 351 of the ISP download server 44-1 determines the product code and the serial number identical to the product code and the serial number received in step S353 from the product codes and the serial numbers stored in the storage 358, and reads the ISP connection ID and the password stored in association with the determined product code and the determined serial number.

In step S355, the CPU 351 of the ISP download server 44-1 sends the ISP connection ID and the password, read in step S354, to the router 12 through the communication unit 359.

In step S212 shown in FIG. 13, the CPU 101 of the router 12 receives, through the WAN communication unit 110, the ISP connection ID and the password sent by the ISP download server 44-1 in step S355. In step S213, the CPU 101 of the router 12 starts a program to set the setting information in the router 12 itself. The CPU 101 of the router 12 thus sets (stores) therewithin the ISP connection ID and the password received in step S212. In step S213 thereafter, the router 12, connected to the ISP server 51-1, monitors WEB pages over the Internet 15.

In step S214, the CPU 101 of the router 12 breaks connection with the ISP download server 44-1.

In this way, the connection setting process is performed with the setting information set in the router 12. As described above, the user 471 sets the router 12 by simply connecting the router 12 to the modem 11 without any input operation of the setting information. Even a user who does not have much experience in the setting of networks easily uses the router 12. Even an experienced user is free from making an error in entering setting information, and convenience is promoted.

Even if the operation unit 106 of the router 12 is not well organized, or even if no operation unit 106 is present, the setting of the router 12 is easily performed, because the operation unit 106 is not used.

As described above, the setting information is directly sent to the router 12 from the ISP download server 44 without being transferred via the simple setting server 42 and the device authentication server 43. The content of the setting information satisfying the requirements of each ISP 14 may be set.

Since the device ID and the passphrase are used for the device authentication only, the leak of the device ID and the passphrase outside the device authentication server 43 is prevented. The use of the device ID and the passphrase in the device authentication prevents access by a device that illegally attempts to request the device authentication server 43 to authenticate the device.

In the above discussion, the processes in steps S206 through S209 shown in FIG. 13 and the processes in steps S321 through S325 shown in FIG. 17 are the device authentication process of the router 12, which is a challenge response method. The challenge response method is one of several device authentication methods. Another device authentication method may be used. For example, a digest authentication method or a server certificate authentication method may be used. In the challenge response method, the device ID and the passphrase authenticate a device. In the digest authentication method, a device ID and a digest authenticate a device. In the server certificate authentication method, a device ID and a public key certificate authenticate a device. In the above discussion, the passphrase is used. Device authentication information of any type compatible with the authentication method in use may be used.

In the above discussion, the setting information includes the ISP connection ID and the password. The setting information is not limited to the ISP connection ID and the password, and may include other information.

The connection setting process of the router 12 of the user 471 who has contracted with the ISP 14-1 has been described. The connection setting process of the router of a user who has contracted with one of the ISP 14-2 through 14-n remains unchanged. More specifically, a user of a router 12 contracts with an ISP 14-n, for example. The ISP 14-n performs the same process as the one performed by the ISP 14-1, and the ISP server 51-n performs the same process as the one performed by the ISP server 51-1.

After a user contracts with one ISP and the connection setting process of the router 12 has been completed, the same user may contract with another ISP, and the connection setting process of the router 12 may be newly performed. For example, now the user has contracted with the ISP 14-1, and the connection setting process of the router 12 is performed to be connectable with the ISP server 51-1. If the user also contracts with the ISP 14-2, the router 12 is set to be connectable with the ISP server 51-2 after performing the same registration process and the same connection setting process. In this case, the user 471 must inform the operator 461 of the product registration number attached to the router 12 (or a packing box containing the router 12) in addition to the registration information containing the user name and the credit card number. The operator 461 inputs the registration information and the product registration number to the ISP server 51-2.

The ISP server 51-2, the device authentication server 43, and the ISP download server 44-2 perform the same registration process as illustrated in the flowchart in FIG. 10. The connection setting process is then performed. More specifically, the router 12 performs the process of the flowchart of FIG. 13, the BAS 31 performs the process of the flowchart of FIG. 14, the RADIUS server 32 performs the process of the flowchart of FIG. 15, the simple setting server 42 performs the process of the flowchart of FIG. 16, the device authentication server 43 performs the process of the flowchart of FIG. 17, and the ISP download server 44-2 performs the process of the flowchart of FIG. 18. Subsequent to the connection setting process, the router 12, connected to the ISP server 51-2, may acquire HTML on WEB pages over the Internet 15.

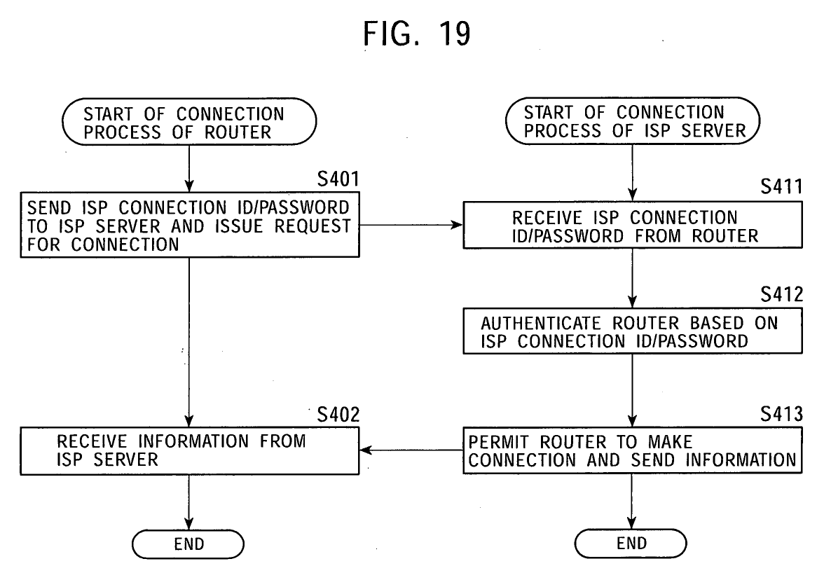

The process of connecting the router 12 to the ISP server 51-1 is discussed with reference to the flowchart in FIG. 19.

In step S401, the CPU 101 of the router 12 sends the (stored) setting information (the ISP connection ID and the password) to the ISP server 51-1 through the WAN communication unit 110.

In step S411, the CPU 401 of the ISP server 51-1 receives the ISP connection ID and the password from the router 12. The ISP server 51-1 has already stored the ISP connection ID and the password of each router owned by the contract user in the storage 408 in step S103 as shown in FIG. 10. In step S412, the CPU 401 of the ISP server 51-1 authenticates the router 12 by determining whether an ISP connection ID and a password identical to those received in step S411 are stored in the storage 408.

If an ISP connection ID and a password identical to those received in step S411 are stored in the storage 408, the process proceeds to step S413. In step S413, the CPU 401 of the ISP server 51-1 permits the router 12 to be connected thereto, and sends information desired by the router 12 to the router 12.

The CPU 101 of the router 12 receives the desired information from the ISP server 51-1 in step S402.

In this way, the router 12 is connected to the ISP server 51-1.

If an ISP connection ID and a password identical to those received in step S411 are not found in the storage 408, the ISP server 51-1 reports an authentication error to the router 12.

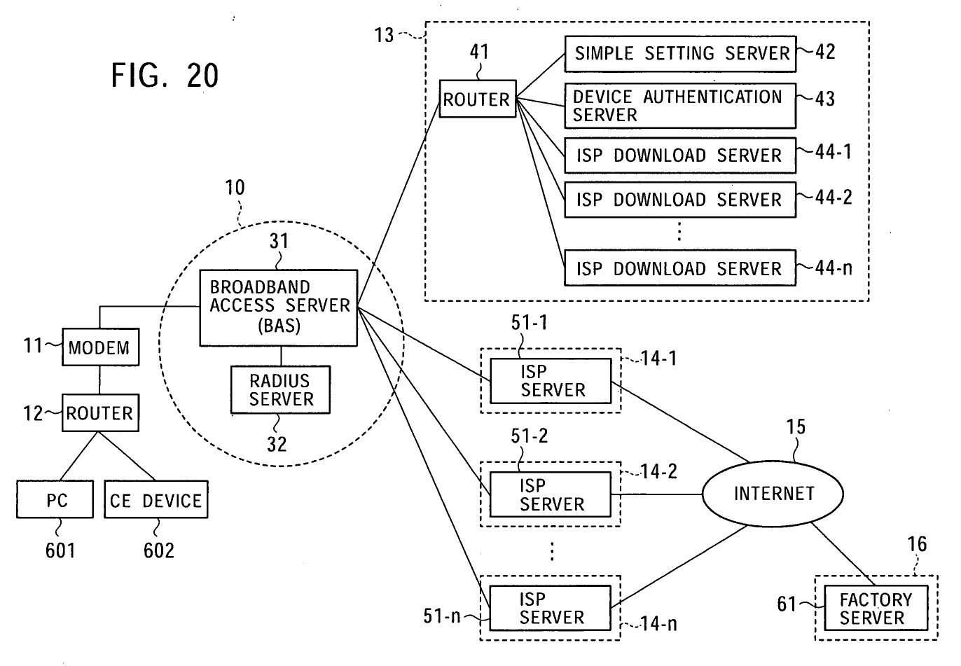

The router 12, now connectable with the ISP server 51-1, may be connected to a personal computer (PC) 601 or a CE device 602 as shown in FIG. 20. As shown, the PC 601 and the CE device 602 are connected to a LAN communication unit 109 of the router 12. The rest of the structure of the system shown in FIG. 20 remains unchanged from FIG. 1. The PC 601 and the CE device 602 acquire HTML data on a desired WEB page over the Internet 15 through the router 12 and present the HTML data on a screen thereof.

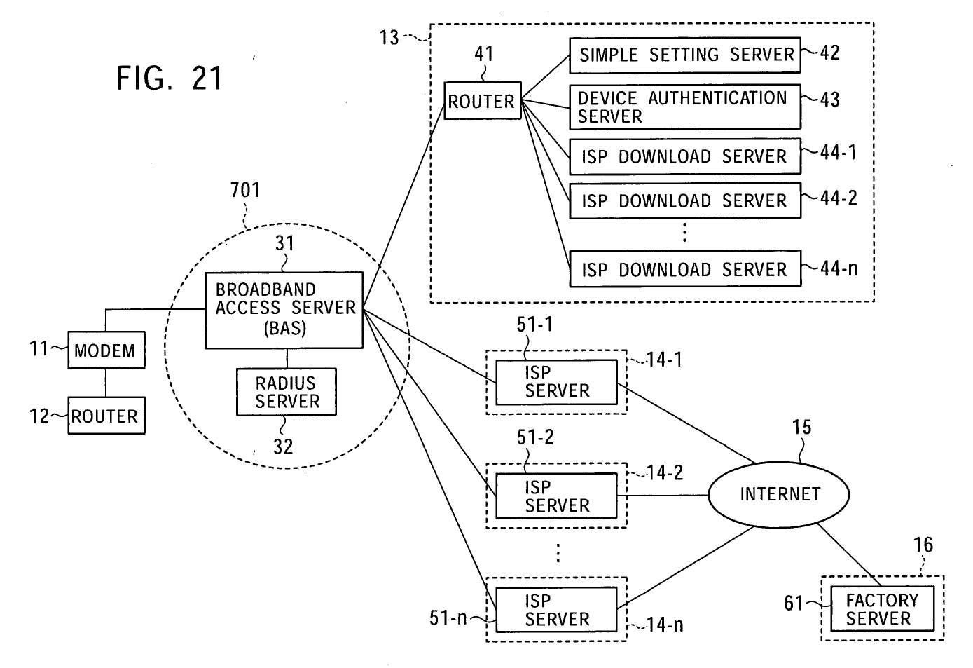

In the above discussion, the ADSL operator network 10 is used. The present invention may be applied to another system. More specifically, FIG. 21 is a block diagram illustrating another information processing system that uses a fiber to the home (FTTH) network 701 instead of the ADSL operator network 10 shown in FIG. 1. The rest of the structure of the system shown in FIG. 21 remains unchanged from the system shown in FIG. 1. When the FTTH network 701 is used as shown in FIG. 21, the registration process, the connection setting process, and the connection process are performed in the same way as in the system of FIG. 1 containing the ADSL operator network 10.

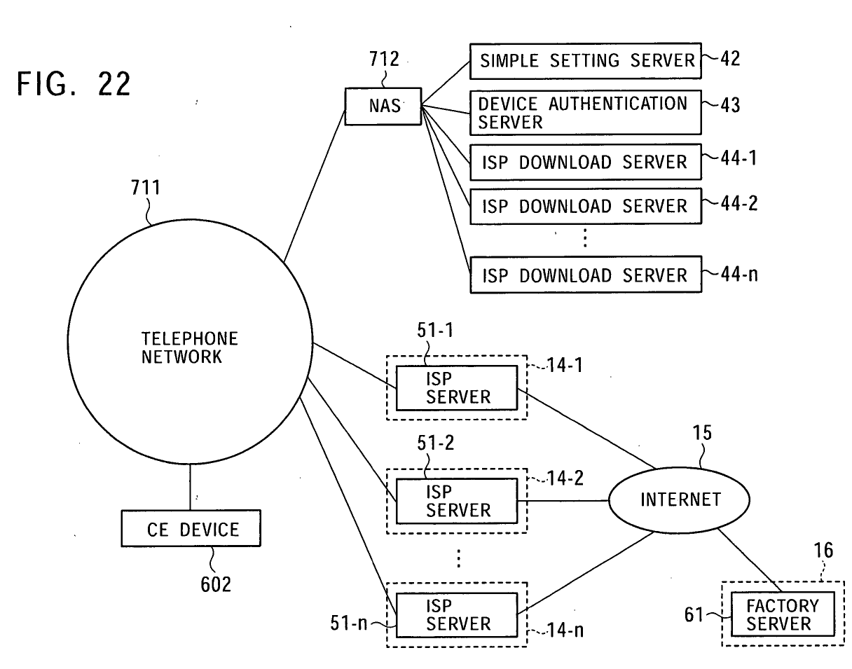

The present invention also may be applied to a fixed telephone network rather than the ADSL operator network 10. FIG. 22 illustrates a system in which the CE device 602 is connected to the Internet 15 through a fixed telephone network 711 (in a dial-up connection). As shown, the fixed telephone network 711 replaces the ADSL operator network 10. Furthermore, a network access server (NAS) 712 replaces the router 41. The CE device 602 stores beforehand a simple setting ID, a password, and a telephone number as a connection destination thereof. The CE device 602 first dials the telephone number of the connection destination, and establishes connection with the simple setting server 42 using the simple setting ID and the password. The device authentication server 43 then authenticates the device, and the CE device 602 acquires the ISP connection ID and the password from the ISP download server 44-1. The CE device 602 sets the acquired ISP connection ID and password therewithin, and connects itself with the Internet 15 through the ISP server 51-1 using the ISP connection ID and the password. In this way, the CE device 602 accesses the Internet 15.

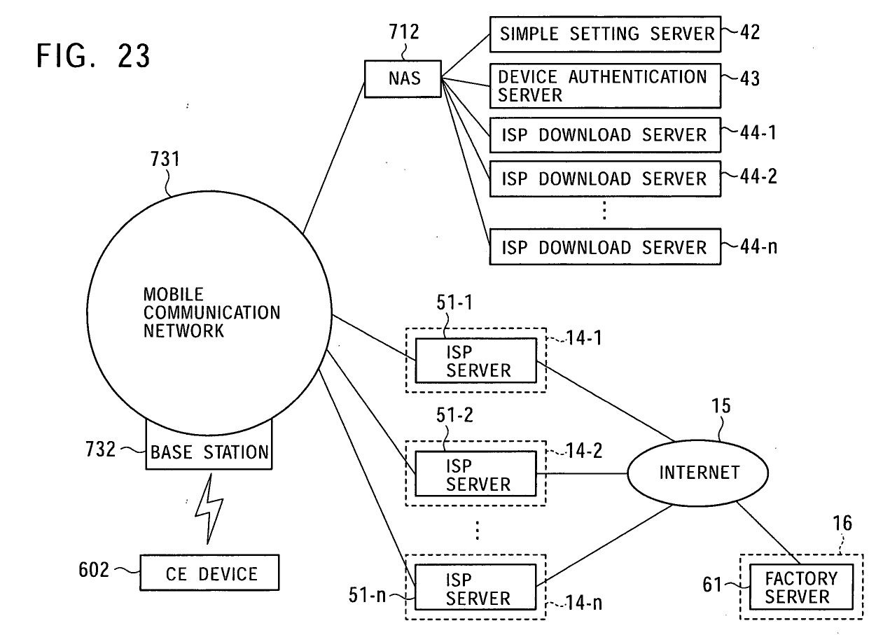

The present invention also may be applied to a system that uses a mobile communication network rather than the ADSL operator network 10. FIG. 23 illustrates such a system in which the CE device 602 is connected to the Internet 15 through a mobile communication network 731. As shown, the mobile communication network 731 replaces the ADSL operator network 10 illustrated in FIG. 1. Furthermore, an NAS 712 replaces the router 41 shown in FIG. 1. The CE device 602 performs wireless communications with a base station 732. The CE device 602 stores beforehand a simple setting ID, a password, and a telephone number as a connection destination thereof. The CE device 602 first dials the telephone number of the connection destination, and establishes connection with the simple setting server 42 using the simple setting ID and the password. The device authentication server 43 then authenticates the device, and the CE device 602 acquires the ISP connection ID and the password from the ISP download server 44-1. The CE device 602 sets the acquired ISP connection ID and password therewithin, and connects itself with the Internet 15 through the ISP server 51-1 using the ISP connection ID and the password. In this way, the CE device 602 accesses the Internet 15.

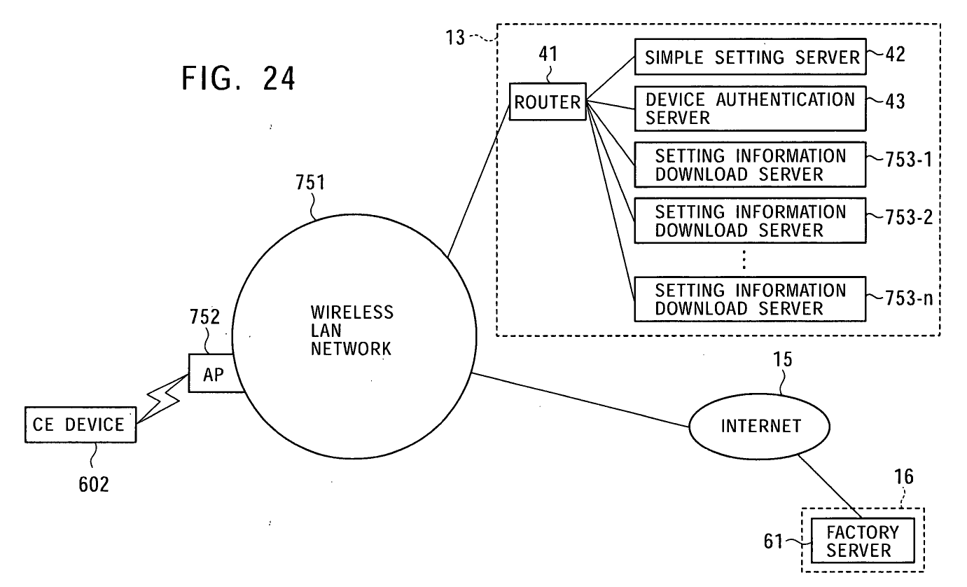

The present invention may be further applied to a system that uses a wireless LAN network rather than the ADSL operator network 10. FIG. 24 illustrates such a system in which the CE device 602 is connected to the Internet 15 through a wireless LAN network 751. As shown, the wireless LAN network 751 replaces the ADSL operator network 10 illustrated in FIG. 1. The CE device 602 performs wireless communications with a wireless LAN access point (AP) 752. The CE device 602 stores beforehand an ESS-ID and a WEP key for connection with the simple setting server 42 and the URL of the simple setting server 42. The CE device 602 first accesses the URL of the simple setting server 42. The device authentication server 43 performs device authentication. The CE device 602 then acquires the ESS-ID and WEP key for Internet connection from a setting information download server 753-1. The CE device 602 sets the acquired ESS-ID and WEP key for Internet connection therewithin, and establishes connection with the Internet 15 using the ESS-ID and WEP key for Internet connection. In this way, the CE device 602 accesses the Internet 15.

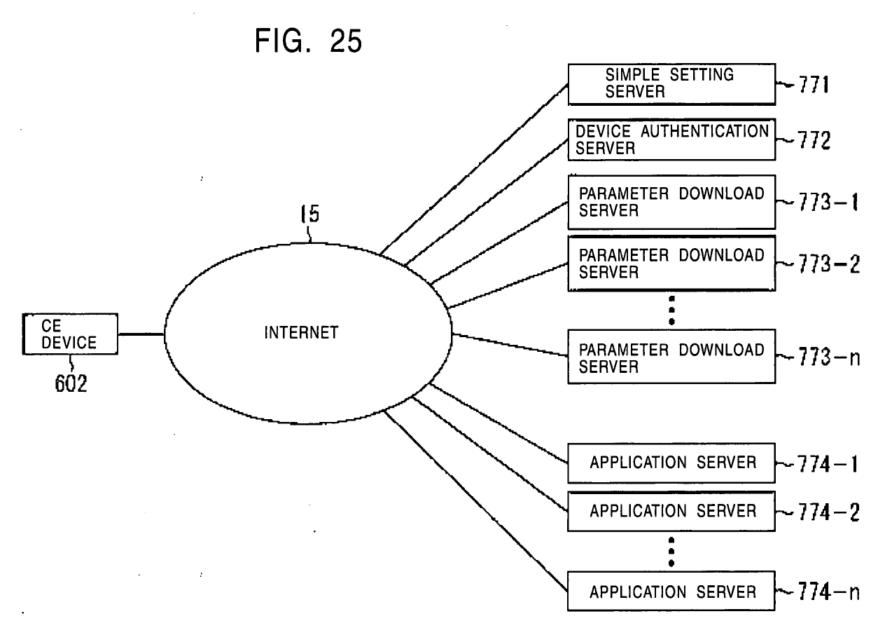

The present invention may be applied in the downloading of information required to enjoy a service provided over the Internet 15. FIG. 25 is a block diagram of yet a further information processing system implementing the present invention. As shown, the CE device 602 stores beforehand a simple setting ID, a password, and the URL of a simple setting server 771. FIG. 25 illustrates the CE device 602 in the connected state thereof. The CE device 602 first accesses the URL of the simple setting server 771. The device authentication server 772 authenticates the CE device 602, and then the CE device 602 downloads, from a parameter download server 773-1, parameters required to use the service (such as the ID, the password, the URL of the application server 774-1, and the nickname of the user). Using the downloaded parameters, the CE device 602 accesses the application server 774-1 to use the service.

In accordance with the present invention, the CE device 602 is automatically connected to the Internet 15 without user intervention to input the setting information.

Referring to FIG. 1, the simple setting server 42, the device authentication server 43, and the ISP download servers 44-1 through 44-n are connected to the same router 41 to form a LAN 13. It is not necessary to connect the simple setting server 42, the device authentication server 43, the ISP download servers 44-1 through 44-n to the same router 41. For example, the same apparatus may perform the process of the simple setting server 42 and the process of the device authentication server 43.

As shown in FIG. 10, the user 471 is registered as a member of the ISP 14-1. More specifically, in step S104, the operator 461 of the ISP server 51-1 enters the product registration number attached to the router 12A delivered to the user 471. Thus, the ISP connection ID and the password assigned to the user 471 are associated with the product code and the serial number identifying the CE device (the router 12A) (step S132).

In the delivery of the router 12A, time and costs are much more reduced when the router 12A is directly delivered from the factory 16 to the user home 451 with the factory 16 notified of the destination (such as the address of the user home 451) than when the router 12A is delivered from the factory 16 to the user home 451 via the ISP 14-1.

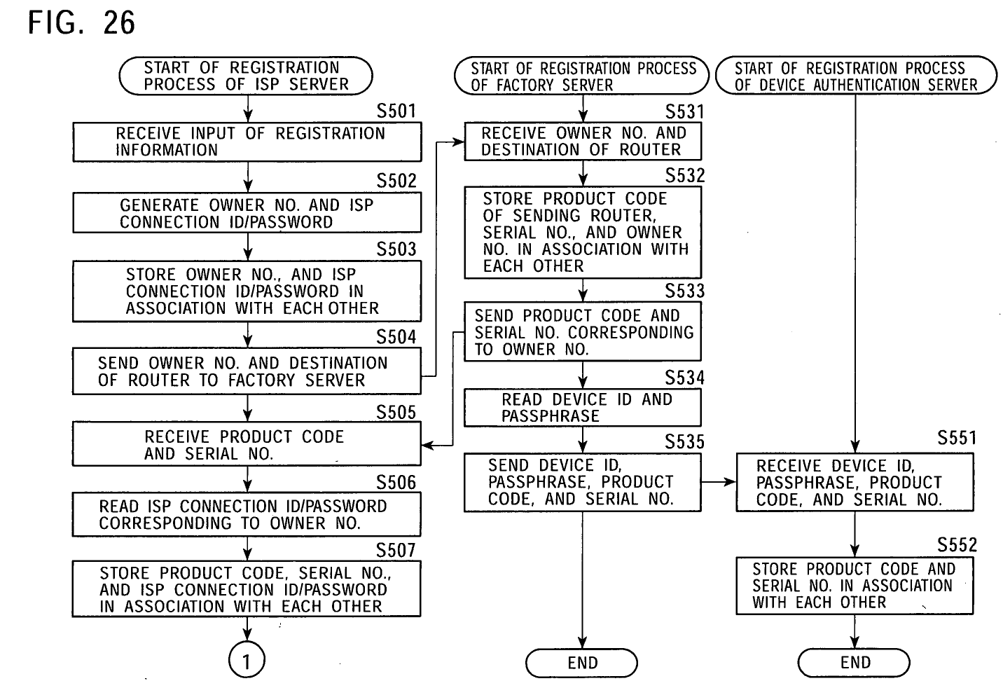

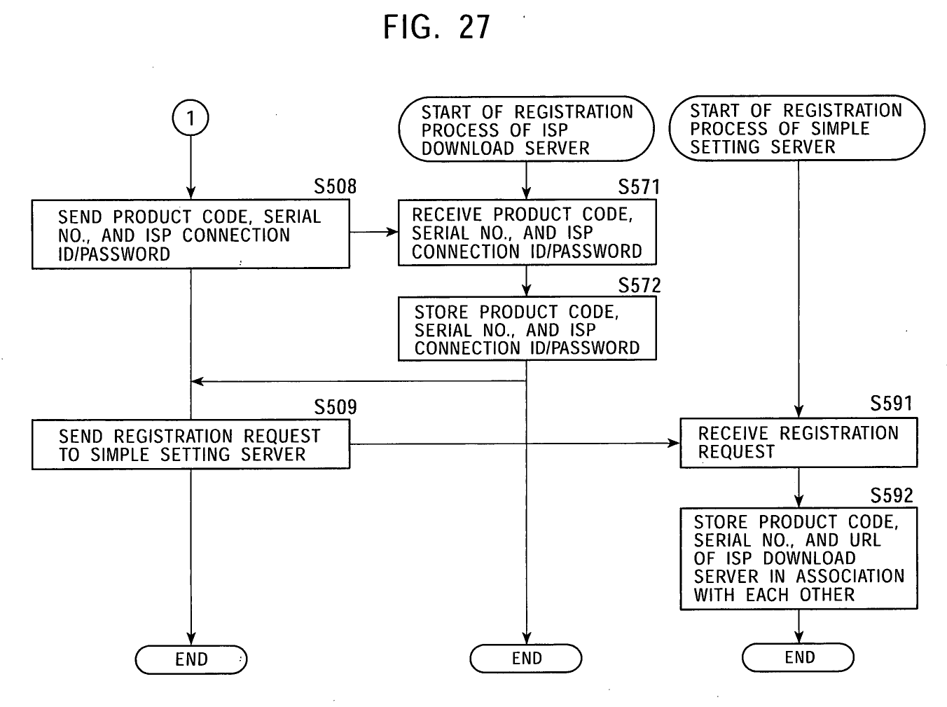

Referring to FIGS. 26 and 27, the process of registering the user 471 as a member of the ISP 14-1 is discussed. Here, the router 12A is directly delivered from the factory 16 to the user home 451.

In step S501 shown in FIG. 26, the CPU 401 of the ISP server 51-1 receives the registration information containing a user name, an address (the delivery destination of the router 12A), and a credit card number of the user from the operator 461 through the input unit 406, and then temporarily stores the registration information in the RAM 403.

In step S502, the CPU 401 of the ISP server 51-1 generates and temporarily stores an owner number, an ISP connection ID and a password of the user in the RAM 403. The owner number is a number identifying the user 471, and is generated based on the registration information received in step S501.

In step S503, the CPU 401 of the ISP server 51-1 stores, in the storage 408, the owner number, the ISP connection ID and the password generated in step S502, in association with each other. The storage 408 thus stores the owner number, the ISP connection ID and the password in association with each other on a user by user basis with each user having contracted with the ISP 14-1. The storage 408 also stores the registration information, received in step S501, in association with the owner number.

In step S504, the CPU 401 of the ISP server 51-1 sends the owner number and the destination of the router 12A to the factory server 61. Since the factory server 61 is identical in structure to the BAS 31 already described with reference to FIG. 3, the factory server 61 is described with reference to FIG. 3.

In step S531, the CPU 151 of the factory server 61 receives the owner number and the delivery destination of the router 12A sent by the ISP server 51-1 in step S504. The factory 16 prepares a device (the router 12A, for example) to be delivered to the delivery destination received in step S531. The product code and the serial number of the router 12A to be delivered are input to the factory server 61. The product code and the serial number of the router 12A may be input by an operator of the factory server 61 or may be automatically input by reading information such as a bar code attached to the router 12A.

In step S532, the CPU 151 of the factory server 61 stores, in the storage 158, the product code and the serial number of the router 12A in association with the owner number received in step S531. In step S533, the CPU 151 of the factory server 61 sends the product code and the serial number corresponding to the owner number received in step S531 (the product code and the serial number of the router 12A) to the ISP server 51-1.

In step S534, the CPU 151 of the factory server 61 reads the device ID and the passphrase, generated when the router 12A was manufactured and stored in the storage 158. In step S535, the CPU 151 of the factory server 61 sends the device ID and the passphrase of the router 12A read in step S534, and the product code and the serial number of the router 12A, to the device authentication server 43.

In step S551, the CPU 301 of the device authentication server 43 receives the device ID and the passphrase of the router 12A and the product code and the serial number of the router 12A sent by the factory server 61 in step S535. In step S552, the CPU 301 of the device authentication server 43 stores, in the storage 308, the information received in step S551.

Here, the factory server 61 sends the device ID and the passphrase of the router 12A and the product code and the serial number of the router 12A to the device authentication server 43 in step S535. In step S551, the device authentication server 43 receives the device ID and the passphrase of the router 12A and the product code and the serial number of the router 12A sent by the factory server 61. In step S552, the device ID, the passphrase, the product code and the serial number are stored. Alternatively, the device authentication server 43 may store beforehand (for example, when the router 12A is manufactured) the device ID, the passphrase, the product code and the serial number of the router 12A.

In step S505, the CPU 401 of the ISP server 51-1 receives the product code and the serial number of the router 12A sent from the factory server 61 in step S533. In step S506, the CPU 401 reads the ISP connection ID and the password corresponding to the owner number (the owner number sent in step S504). In step S507, the CPU 401 stores the product code and the serial number, received in step S505, in association with the ISP connection ID and the password read in step S506. The ISP connection ID and the password assigned to a user (the user 471, for example) are stored in association with the product code and the serial number determining the CE device (the router 12A).

In step S508 shown in FIG. 27, the CPU 401 of the ISP server 51-1 sends, to the ISP download server 44-1, the product code and the serial number, and the ISP connection ID and the password corresponding thereto, stored in step S507.

In step S571, the CPU 351 of the ISP download server 44-1 receives the product code and the serial number, and the ISP connection ID and the password corresponding thereto, sent by the ISP server 51-1 in step S508. In step S572, the CPU 351 stores, in the storage 358, the information received in step S571. A signal indicating that the information received in step S571 is stored is sent to the ISP server 51-1.

When the CPU 401 of the ISP server 51-1 receives, from the ISP download server 44-1, the signal indicating that the information is stored, the process proceeds to step S509. The CPU 401 then sends a registration request to the simple setting server 42. The ISP connection ID and the password of the user 471, the product code and the serial number of the router 12A, and the URL of the ISP download server 44-1, with predetermined header information attached thereto, are sent as the registration request.

In step S591, the CPU 251 of the simple setting server 42 receives the registration request sent by the ISP server 51-1 in step S509. In step S592, the CPU 251 of the simple setting server 42 stores, in the storage 258, the product code and the serial number of the router 12A contained in the registration information received in step S501 in association with the URL of the ISP download server 44-1.

In this way, the user 471 is registered as a member of the ISP 14-1.

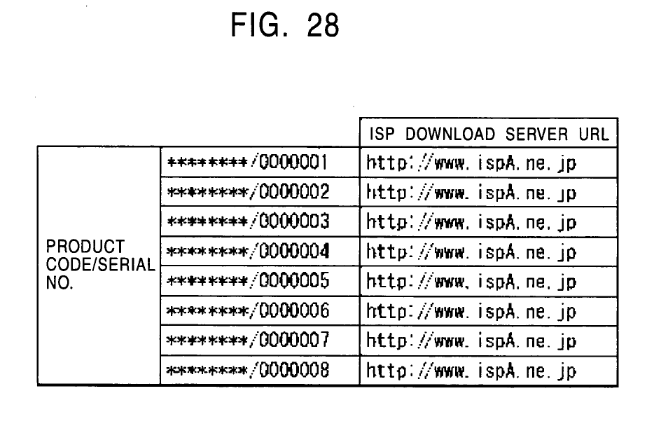

FIG. 28 is a table listing the product code, the serial number, and the URL of the ISP download server, stored in the storage 258 of the simple setting server 42. As illustrated, a URL of an ISP download server is stored corresponding to each of a plurality of product codes and serial numbers. The URLs of the ISP download servers are all “http: //www.ispA.ne.jp” in FIG. 28, but are not always the same in practice.

As already discussed with reference to FIG. 11, the storage 358 of the ISP download server 44-1 stores the product code, the serial number, the ISP connection ID and the password.

The connection process to set the router 12 of the user 471, who has contracted with the ISP 14-1, for the connection of the ISP server 51-1 has already been discussed with reference to FIGS. 13 through 18. A system may be organized to reliably perform authentication in the connection process to improve security. For example, in the connection process illustrated in FIGS. 13 through 18, the simple setting server 42 does not authenticate the router 12 by checking the product code and the serial number of the router 12. Alternatively, the simple setting server 42 may perform authentication by checking the product code and the serial number of the router 12, and only a router 12 that has been successfully authenticated by the simple setting server 42 may be permitted to access the ISP download server 44-1.

The connection process featuring improved security will now be described with reference to FIGS. 29 through 34.

Upon switching on the router 12, the CPU 101 of the router 12 monitors the WAN communication unit 110 and waits on standby in step S701 as shown in FIG. 29 until the WAN communication unit 110 is connected to the modem 11 through a predetermined cable. If the WAN communication unit 110 is connected to the modem 11 through the predetermined cable, the process proceeds to step S702.

In step S702, the CPU 101 of the router 12 reads the simple setting ID and the password stored in the ROM 102 when the router 12 was manufactured in the factory 16, and sends the simple setting ID and the password to the BAS 31 through the WAN communication unit 110. The BAS 31 receives the simple setting ID and the password thus sent. The BAS 31 and the RADIUS server 32 authenticate the router 12 in the same manner as already discussed with reference to FIGS. 14 and 15, and the BAS 31 notifies the router 12 of the result of authentication.

In step S703, the CPU 101 of the router 12 receives, through the WAN communication unit 110, the authentication result sent by the BAS 31 in step S254 as shown in FIG. 14. If the authentication result indicates that the router 12 is permitted to access the simple setting server 42, the device authentication server 43, the ISP download servers 44-1 through 44-n, and the ISPs 14-1 through 14-n, the process proceeds to step S704. Thereinafter, the router 12 is granted a right to access the simple setting server 42 and the device authentication server 43 through the BAS 31. At this point in time, the router 12 is not yet granted a right to access the ISP download server 44. When the URL of the ISP download server 44 is sent from the simple setting server 42 to the router 12, the router 12 is granted a right to access the ISP download server 44.

If the authentication result indicates that the router 12 is not permitted to access the simple setting server 42, the device authentication server 43, the ISP download servers 44-1 through 44-n, and the ISPs 14-1 through 14-n, the CPU 101 of the router 12 causes a predetermined LED of the indicator 107 to light (or blink), thereby alerting the user 471 to the occurrence of an error in the connection setting process. If the router 12 attempts to access the BAS 31 later, the RADIUS server 32 performs the authentication process again.

In step S704, the CPU 101 of the router 12 reads the URL, for access to the simple setting server 42, stored in the ROM 102 when the router 12 was manufactured in the factory 16. The CPU 101 of the router 12 accesses the URL (namely, the simple setting server 42) through the WAN communication unit 110, and requests the simple setting server 42 to send the setting information.

In step S751 shown in FIG. 31, the CPU 251 of the simple setting server 42 receives, through the communication unit 259, the request to send the setting information sent by the router 12 in step S704.

As discussed above, the simple setting server 42 stores beforehand, in the storage 258, the device authentication start trigger requesting the start of the process for authenticating the device (the router 12). In step S752, the CPU 251 of the simple setting server 42 reads the device authentication start trigger from the storage 258, and then sends the device authentication start trigger to the router 12 through the communication unit 259.

In step S705, the CPU 101 of the router 12 receives, through the WAN communication unit 110, the device authentication start trigger sent by the simple setting server 42 in step S752, and temporarily stores the device authorization start trigger in the RAM 103.

In step S706, the CPU 101 of the router 12 generates a random number (the random number generated in step S706 is hereinafter referred to as a challenge), and sends the challenge to the device authentication server 43 through the WAN communication unit 110, while requesting the device authentication server 43 to authenticate the router 12 at the same time. The router 12 sends the challenge to the device authentication server 43 by accessing the URL of the device authentication server 43 contained in the device authentication start trigger. The CPU 101 of the router 12 temporarily stores the generated challenge in the RAM 103.

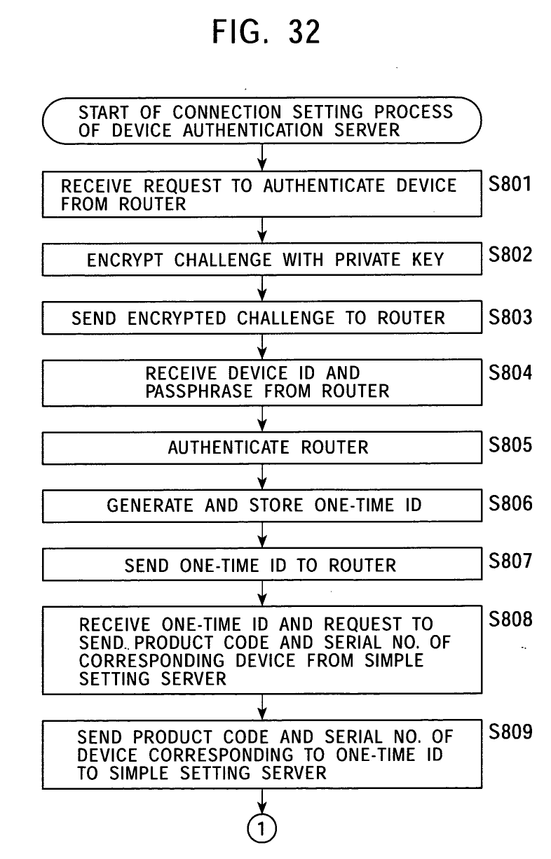

In step S801 shown in FIG. 32, the CPU 301 of the device authentication server 43 receives, through the communication unit 309, the challenge and the device authentication request sent by the router 12 in step S706. As already discussed, the device authentication server 43 causes the storage 308 to store the challenge public key and the challenge private key in association with each other. In step S802, the CPU 301 of the device authentication server 43 reads the challenge private key from the storage 308, and encrypts the challenge received in step S801 with the challenge private key. In step S803, the CPU 301 of the device authentication server 43 sends the challenge encrypted in step S802 to the router 12 through the communication unit 309.

In step S707 shown in FIG. 29, the CPU 101 of the router 12 receives, through the WAN communication unit 110, the encrypted challenge that has been sent by the device authentication server 43 in step S803. As already discussed, the ROM 102 of the router 12 has already stored the challenge public key when the router 12 was manufactured in the factory 16. In step S708, the CPU 101 of the router 12 reads the challenge public key from the ROM 102, and decrypts the encrypted challenge with the challenge public key. The CPU 101 of the router 12 reads, from the RAM 103, the challenge generated in step S706, and compares the decrypted challenge with the read challenge. If the decrypted challenge is found to match the challenge generated in step S706, the CPU 101 of the router 12 determines that the device authentication server 43 is a correct access destination, and the process proceeds to step S709.

In step S709, the CPU 101 of the router 12 reads the device ID and the passphrase stored in the ROM 102, and sends the device ID and the passphrase to the device authentication server 43 through the WAN communication unit 110. In this case, the router 12 sends the device ID and the passphrase with the URL thereof attached thereto to the device authentication server 43.

In step S804 shown in FIG. 32, the CPU 301 of the device authentication server 43 receives, through the communication unit 309, the device ID and the passphrase sent by the router 12 in step S709. The device authentication server 43 has stored, in the storage 308, the device ID, the passphrase, the product code, and the serial number, received from the factory server 61. In step S805, the CPU 301 of the device authentication server 43 determines whether the device ID and the passphrase, received in step S804, are found among the device IDs and the passphrases stored in the storage 308. If the device ID and the passphrase, received in step S804, are found among the device IDs and the passphrases stored in the storage 308, the router 12 is authenticated as a device manufactured in the factory 16, and the process proceeds to step S806.

If it is determined in step S805 that the device ID and the passphrase, received from the router 12 in step S804, are not stored in the storage 308, the CPU 301 of the device authentication server 43 determines that the router 12 is not one shipped from the factory 16, and reports a device authentication error to the router 12. In response to the device authentication error, the router 12 causes the indicator 107 to light (or blink).

In step S806, the CPU 301 of the device authentication server 43 generates a one-time ID that is valid one time only, and stores the generated one-time ID in association with the device ID, the passphrase, the product code and the serial number in the storage 308. The one-time ID, valid one time only, is generated as a result of device authentication. The one-time ID is identification information used to determine the corresponding product code and serial number of the router.

In step S807, the CPU 301 of the device authentication server 43 sends the one-time ID generated in step S806 to the router 12 through the communication unit 309. In this case, the device authentication server 43 sends the one-time ID to the URL of the router 12 attached to the device ID and the passphrase received in step S804.

In step S710 shown in FIG. 29, the CPU 101 of the router 12 receives, through the WAN communication unit 110, the one-time ID sent by the device authentication server 43 in step S807. In step S711, the CPU 101 of the router 12 sends the one-time ID received in step S710 to the simple setting server 42 through the WAN communication unit 110.

In step S753 shown in FIG. 31, the CPU 251 of the simple setting server 42 receives, through the communication unit 259, the one-time ID sent by the router 12 in step S711. In step S754, the CPU 251 of the simple setting server 42 sends, through the communication unit 259, the one-time ID received in step S753 to the device authentication server 43, and requests the device authentication server 43 to send the product code and the serial number corresponding to the one-time ID.

In step S808 shown in FIG. 32, the CPU 301 of the device authentication server 43 receives, through the communication unit 309, the one-time ID and the request to send the product code and the serial number corresponding to the one-time ID, sent by the simple setting server 42 in step S754. In step S809, the CPU 301 of the device authentication server 43 searches for and reads, in the storage 308, the product code and the serial number corresponding to the one-time ID received in step S808, and sends the product code and the serial number to the simple setting server 42.

In step S755 shown in FIG. 31, the CPU 251 of the simple setting server 42 receives, through the communication unit 259, the product code and the serial number sent by the device authentication server 43. In step S756, the CPU 251 of the simple setting server 42 searches for the URL of the ISP download server corresponding to the product code and the serial number received in step S755. As already discussed with reference to FIG. 28, the storage 258 of the simple setting server 42 stores the URLs of the ISP download servers corresponding to the plurality of product codes and serial numbers. The CPU 251 of the simple setting server 42 searches for those identical to the product code and the serial number received in step S755 among the stored product codes and the serial numbers. If those identical to the product code and the serial number are not found, the URL of the ISP download server is not stored in step S592. In the process in step S756, the simple setting server 42 in practice authenticates the router 12.

In step S757, the CPU 251 of the simple setting server 42 sends to the router 12 the URL of the ISP download server (the ISP download server 44-1, for example) corresponding to the product code and the serial number found in the search in step S756.

In step S712 shown in FIG. 29, the CPU 101 of the router 12 receives, through the WAN communication unit 110, the URL of the ISP download server 44-1 sent by the simple setting server 42 in step S757. The router 12 is thus granted a right to access the ISP download server 44-1. In step S713, the CPU 101 requests the setting information from the ISP download server 44-1 based on the URL received in step S712.

In step S851 shown in FIG. 34, the CPU 351 of the ISP download server 44-1 receives the request for the setting information sent by the router 12 in step S713. In step S852, the CPU 351 reads the device authentication start trigger from the storage 358, and sends the device authentication start trigger to the router 12 through the communication unit 359. It is assumed that the device authentication start trigger contains the URL of the device authentication server 43 as the device authentication start trigger also contains the URL of the device authentication server 43 when being sent from the simple setting server 42, and it is also assumed that the device authentication start trigger is stored beforehand in the storage 358. Alternatively, the device authentication start trigger then sent may contain a URL of a device authentication server different from the device authentication server 43.

If the ISPs 14-1 through 14-n respectively authenticate the router 12, device authentication servers (for example, device authentication servers 43-1 through 43-n), different from the device authentication server 43, must authenticate the router 12. In step S752 shown in FIG. 31, the simple setting server 42 sends the device authentication start trigger to the router 12, and the device authentication server 43 authenticates the router 12. In step S852, the device authentication start trigger containing a URL of the device authentication server 43-1 dedicated to the ISP 14-1 may be sent, and the device authentication server 43-1 may authenticate the router 12.

In this way, the ISPs 14-1 through 14-n individually authenticate the router 12.

In step S714 shown in FIG. 29, the CPU 101 of the router 12 receives the device authentication start trigger that has been sent by the ISP download server 44-1 in step S852. In step S715, the CPU 101 requests the device authentication server 43 to authenticate the router 12 based on the URL of the device authentication server 43 (another authentication server is acceptable) contained in the device authentication start trigger. Like in step S706, the CPU 101 generates a challenge (a random number), sends the challenge to the device authentication server 43 through the WAN communication unit 110, and requests the device authentication server 43 to authenticate the router 12. The CPU 101 causes the RAM 103 to temporarily store the generated challenge.

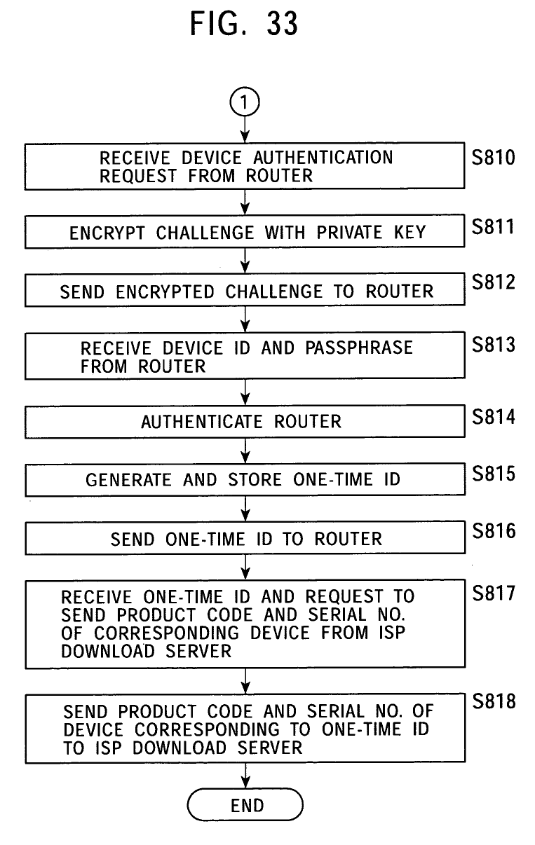

In step S810 shown in FIG. 33, the CPU 301 of the device authentication server 43 receives, through the communication unit 309, the challenge and the device authentication request sent by the router 12 in step S715. In step S811, the CPU 301 of the device authentication server 43 reads the challenge private key from the storage 308, and encrypts the challenge received in step S810 with the challenge private key. In step S812, the CPU 301 of the device authentication server 43 sends to the router 12, through the communication unit 309, the challenge encrypted in step S811.

In step S716 shown in FIG. 30, the CPU 101 of the router 12 receives, through the WAN communication unit 110, the encrypted challenge sent by the device authentication server 43 in step S812. In step S717, the CPU 101 reads the challenge public key from the ROM 102, and decrypts the encrypted challenge with the challenge public key. The CPU 101 reads the challenge generated in step S715, and compares the decrypted challenge with the challenge generated in step S715. If the decrypted challenge matches the challenge generated in S715, the CPU 101 of the router 12 determines the device authentication server 43 is a correct access destination, and the process proceeds to step S718.

In step S718, the CPU 101 of the router 12 reads the device ID and the passphrase stored in the ROM 102, and sends the device ID and the passphrase to the device authentication server 43 through the WAN communication unit 110. In this case, the router 12 sends the device ID and the passphrase with the URL thereof attached thereto to the device authentication server 43.

In step S813 shown in FIG. 33, the CPU 301 of the device authentication server 43 receives, through the communication unit 309, the device ID and the passphrase sent by the router 12 in step S718. In step S814, the CPU 301 determines whether the device ID and the passphrase received in step S813 are found among the device IDs and the passphrases stored in the storage 308. If the device ID and the passphrase received in step S813 are found among the device IDs and the passphrases stored in the storage 308, the router 12 is authenticated as being one manufactured in the factory 16, and the process proceeds to step S815.

If the device ID and the passphrase received from the router 12 in step S813 are not found among the device IDs and the passphrases stored in the storage 308, the CPU 301 of the device authentication server 43 determines that the router 12 is not one shipped from the factory 16, and reports a device authentication error to the router 12. In response to the device authentication error, the router 12 causes the indicator 107 to light (or blink).

In step S815, the CPU 301 of the device authentication server 43 generates a one-time ID that is valid one time only, and stores the generated one-time ID in association with the device ID, the passphrase, the product code and the serial number in the storage 308. The one-time ID, valid one time only, is generated as a result of device authentication. The one-time ID is identification information used to determine the corresponding product code and serial number of the router.

In step S816, the CPU 301 of the device authentication server 43 sends the one-time ID, generated in step S815, to the router 12 through the communication unit 309. In this case, the device authentication server 43 sends the one-time ID to the URL of the router 12 attached to the device ID and the passphrase received in step S813.

In step S719 shown in FIG. 30, the CPU 101 of the router 12 receives, through the WAN communication unit 110, the one-time ID sent by the device authentication server 43 in step S816. In step S720, the CPU 101 of the router 12 sends, to the ISP download server 44-1 through the WAN communication unit 110, the one-time ID received in step S719.

In step S853 shown in FIG. 34, the CPU 351 of the ISP download server 44-1 receives, through the communication unit 359, the one-time ID sent by the router 12 in step S720. In step S854, the CPU 351 sends, through the communication unit 359, the one-time ID, received in step S853, to the device authentication server 43, and requests the device authentication server 43 to send the product code and the serial number corresponding to the one-time ID.

In step S817 shown in FIG. 33, the CPU 301 of the device authentication server 43 receives, through the communication unit 309, the one-time ID and the request to send the product code and the serial number corresponding to the one-time ID sent from the ISP download server 44-1 in step S854. The device authentication server 43 has already stored the one-time ID, and the device ID and the passphrase, and the product code and the serial number in association with the one-time ID in step S815. In step S818, the CPU 301 determines the one-time ID identical to the one-time ID received in step S817 from among the one-time IDs stored in the storage 308. The CPU 301 searches for and reads, in the storage 308, the product code and the serial number corresponding to the determined one-time ID. If the one-time ID received in step S817 is not authentic, the CPU 301 is unable to determine the one-time ID in step S818. In this way, the device authentication server 43 practically authenticates the router 12.

The CPU 301 of the device authentication server 43 sends the read product code and serial number to the ISP download server 44-1 through the communication unit 309.

In step S855 shown in FIG. 34, the CPU 351 of the ISP download server 44-1 receives, through the communication unit 359, the product code and the serial number sent by the device authentication server 43 in step S818. In step S572 shown in FIG. 27, the ISP download server 44-1 stores the product code, the serial number, the ISP connection ID and the password in association with each other in the storage 358. In step S856 shown in FIG. 34, the CPU 351 of the ISP download server 44-1 determines the product code and the serial number identical to the product code and the serial number received in step S855 from among the product codes and the serial numbers stored in the storage 358. The CPU 351 searches for and reads the ISP connection ID and the password stored in association with the determined product code and serial number. An unsuccessful search means that the ISP connection ID and the password were not stored in step S572. In step S856, the ISP download server 44-1 performs a practical authentication process on the router 12.

In step S857, the CPU 351 sends, through the communication unit 359 to the router 12, the ISP connection ID and the password read in step S856.

In step S721 shown in FIG. 30, the CPU 101 of the router 12 receives, through the WAN communication unit 110, the ISP connection ID and the password sent by the ISP download server 44-1 in step S857. In step S722, the CPU 101 starts a program for entering the setting information in the router 12 itself, and sets (stores) the ISP connection ID and the password received in step S721. Subsequent to step S722, the router 12, connected to the ISP server 51-1, is enabled to view WEB pages over the Internet 15 through the ISP server 51-1.

In step S723, the CPU 101 of the router 12 breaks the connection with the ISP download server 44-1.

The connection setting process is performed as described above, and the setting information is entered into the router 12. In the connection setting process discussed with reference to FIGS. 29 through 34, the simple setting server 42 and the ISP download server 44-1 individually send the device authentication start triggers. The simple setting server 42 and the ISP download server 44-1 are enabled to independently authenticate the router 12. In comparison with the connection setting process discussed with reference to FIGS. 13 through 18, the authentication of the device (the router 12) is reliably performed. The security of the system is thus heightened.

The registration process for registering the user 471 as a member of the ISP 14-1 when the router 12A is directly delivered from the factory 16 to the user home 451 has already been described with reference to FIGS. 26 and 27. Referring to FIGS. 26 and 27, the ISP servers 51-1 through 51-n of the individual ISPs (the ISPs 14-1 through 14-n) perform the process of registering member information. In practice, to heighten operation efficiency, the registration of the member information may be outsourced to an outside company. The member information is thus collectively registered in the center of the outside company.

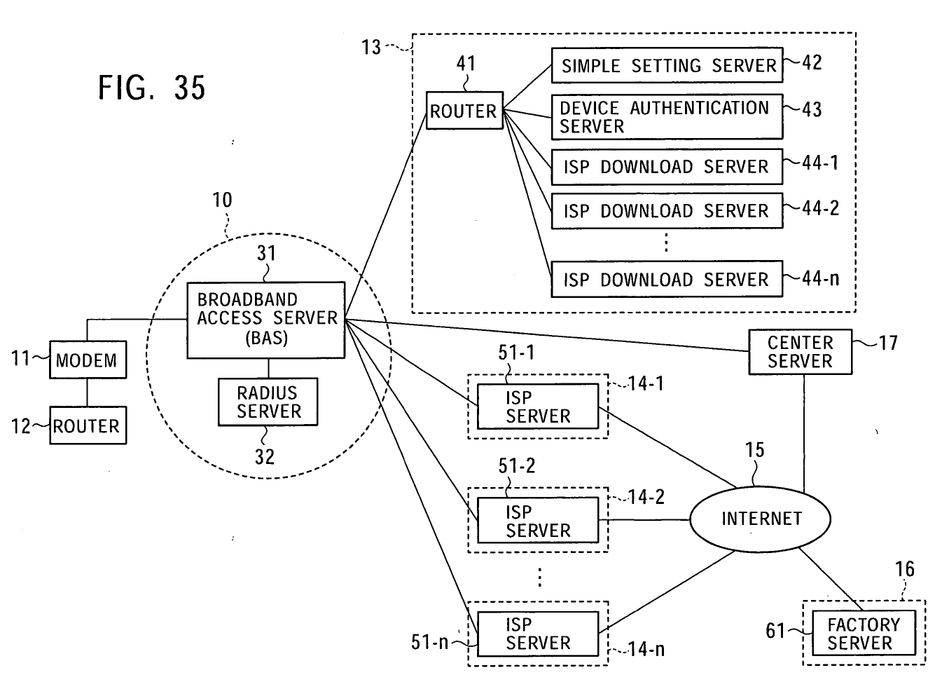

FIG. 35 illustrates an information processing system in accordance with one embodiment of the present invention, wherein the member information, etc. is collectively registered in the center of the outside company. As illustrated, elements identical to those discussed with reference to FIG. 1 are designated with the same reference numerals and a discussion thereof is omitted here. FIG. 35, different from FIG. 1, additionally shows a center server 17. The center server 17 is a server installed in the center of the outside company to which the ISPs 14-1 through 14-n outsource operations. The center server 17 registers the member information, and information concerning the ISP (such as the ISP 14-1) that has the user 471 as a member thereof.

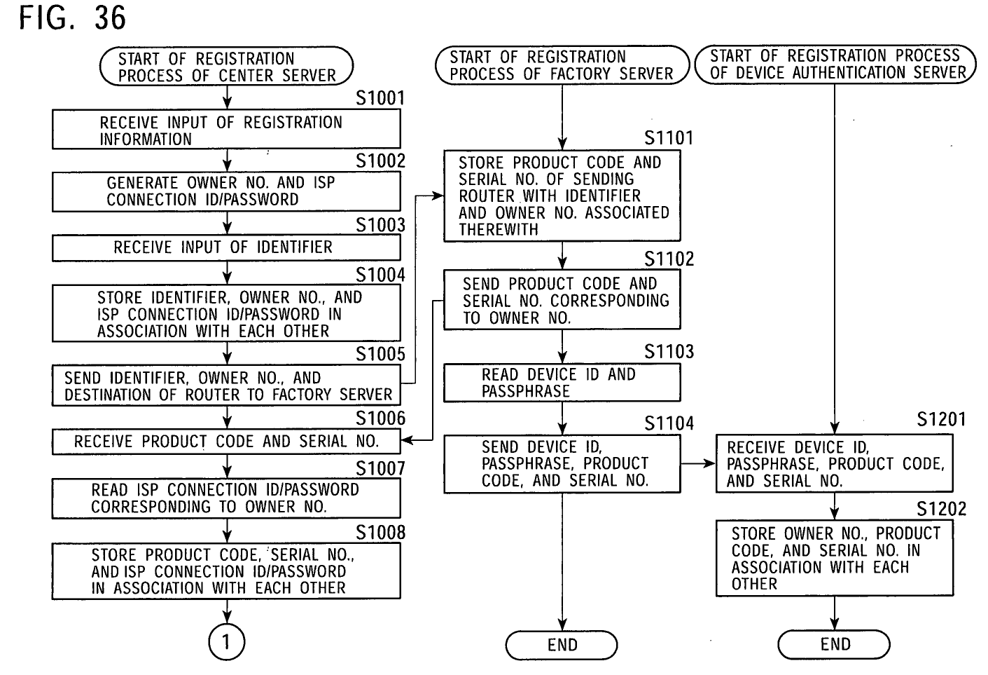

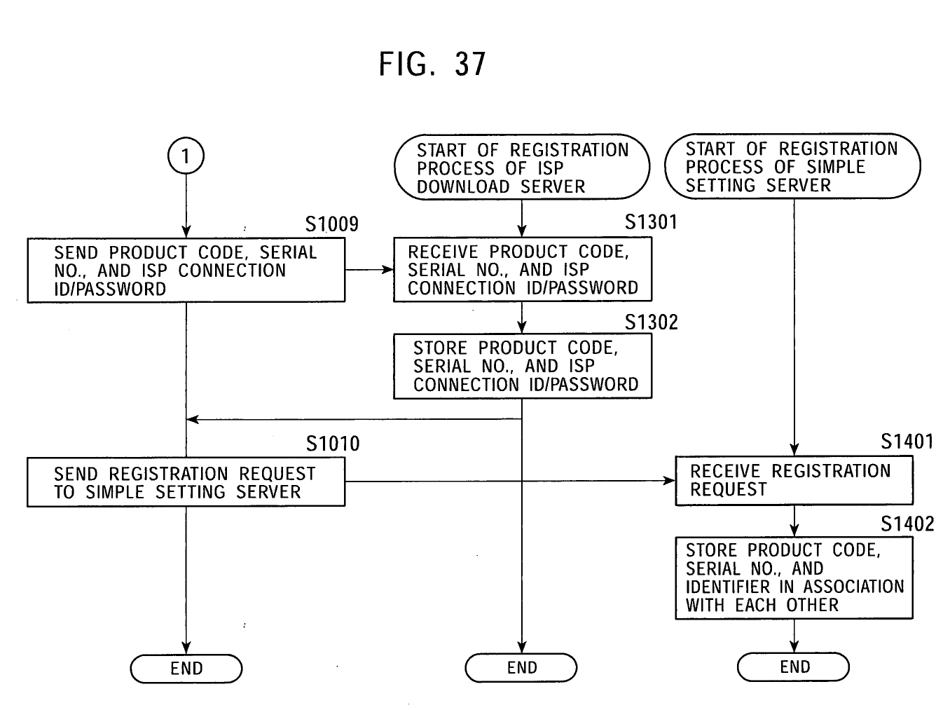

Referring to FIGS. 36 and 37, the process of registering the user 471 in the system shown in FIG. 35 as a member of the ISP (the ISP 14-1, for example) is described.

In step S1001 shown in FIG. 36, the CPU 401 of the center server 17 receives registration information containing a user name, an address (the delivery destination of the router), and a credit card number of the user through the input unit 406 from an operator of the center, and temporarily stores the registration information in the RAM 403. Since the center server 17 is identical in structure to the ISP server shown in FIG. 8, the center server 17 is described with reference to FIG. 8.

In step S1002, the CPU 401 of the center server 17 generates and temporarily stores an owner number, an ISP connection ID and a password of the user in the RAM 403. The owner number identifies the user 471, and is generated based on the registration information received in step S1001.

In step S1003, the CPU 401 of the center server 17 receives the input of an identifier. The identifier is information determining the ISP, and is input by the operator of the center in response to a request from the user 471. Now, the user 471 requests a membership from the ISP 14-1. The identifier identifying the ISP 14-1 is input and is also stored in the RAM 403.

The number of identifiers received in step S1003 is not limited to one. A plurality of identifiers may be accepted. In this case, the user 471 is (tentatively) registered as a member of a plurality of ISPs corresponding to the plurality of identifiers. When the connection setting process is performed with the ISP server subsequent to the process illustrated in FIGS. 36 and 37, a server actually downloading information (the ISP connection ID and the password) required for the connection setting is selected.

In step S1004, the CPU 401 of the center server 17 stores, in the storage 408, the owner number, the ISP connection ID and the password, generated in step S1002, and the identifier input in step S1003, in association with each other. In this way, the storage 408 stores the owner number, the ISP connection ID, the password, and the identifier in association with each other on a user by user basis for each user who has contracted with the ISP 14-1. The registration information received in step S1001 is also stored in the storage 408 in association with the owner number.

In step S1005, the CPU 401 of the center server 17 sends the identifier, the owner number, and the destination of the router to the factory server 61.

In step S1101, the CPU 151 of the factory server 61 receives the identifier, the owner number, and the destination of the router sent by the center server 17 in step S1005. The factory 16 prepares a device (the router 12A, for example) to deliver to the destination received in step S1101. The identifier received in step S1101 is stored together with the above-referenced device ID and passphrase in the ROM 102 of the router 12A.

The product code and the serial number of the router 12A to be delivered are input to the factory server 61. The product code and the serial number of the router 12A may be input by the operator of the factory server 61 or may be automatically input by reading information such as a bar code attached to the router 12A.

Also in step S1101, the CPU 151 of the factory server 61 stores, in the storage 158, the product code and the serial number of the router 12A in association with the received owner number. In step S1102, the CPU 151 of the factory server 61 sends the product code and the serial number corresponding to the owner number received in step S1101 (the product code and the serial number of the router 12A) to the center server 17.

In step S1103, the CPU 151 of the factory server 61 reads the device ID and the passphrase, generated when the router 12A was manufactured and stored in the storage 158. In step S1104, the CPU 151 of the factory server 61 sends the device ID and the passphrase of the router 12A read in step S1103, and the product code and the serial number of the router 12A, to the device authentication server 43.

In step S1201, the CPU 301 of the device authentication server 43 receives the device ID and the passphrase of the router 12A and the product code and the serial number of the router 12A sent by the factory server 61 in step S1104. In step S1202, the CPU 301 of the device authentication server 43 stores, in the storage 308, the information received in step S1201.

In step S1006, the CPU 401 of the center server 17 receives the product code and the serial number of the router 12A sent from the factory server 61 in step S1102. In step S1007, the CPU 401 reads the ISP connection ID and the password corresponding to the owner number (the owner number sent in step S1005). In step S1008, the CPU 401 stores the product code and the serial number, received in step S1006, in association with the ISP connection ID and the password read in step S1007. The ISP connection ID and the password assigned to a user (the user 471, for example) are stored in association with the product code and the serial number determining the CE device (the router 12A).

In step S1009 shown in FIG. 37, the CPU 401 of the center server 17 identifies the ISP in response to the identifier received in step S1003 as shown in FIG. 36, and sends, to the ISP download server of that ISP, the product code and the serial number, and the ISP connection ID and the password corresponding thereto, stored in step S1008. Here, the identifier received in step S1003 is one identifying the ISP 14-1, and in step S1009, the product code and the serial number, and the ISP connection ID and the password corresponding thereto, are sent to the ISP download server 44-1.

In step S1301, the CPU 351 of the ISP download server 44-1 receives the product code and the serial number, and the ISP connection ID and the password corresponding thereto, sent by the center server 17 in step S1009. In step S1302, the CPU 351 stores, in the storage 358, the information received in step S1301. A signal indicating that the information received in step S1301 is stored is sent to the center server 17.

When the CPU 401 of the center server 17 receives, from the ISP download server 44-1, the signal indicating that the information is stored, the process proceeds to step S1010. The CPU 401 then sends a registration request to the simple setting server 42. The product code and the serial number of the router 12A, and the identifier input in step S1003 with predetermined header information attached thereto, are sent as the registration request.

In step S1401, the CPU 251 of the simple setting server 42 receives the registration request sent by the center server 17 in step S1010. In step S1402, the CPU 251 of the simple setting server 42 stores, in the storage 258, the product code and the serial number of the router 12A contained in the registration information received in step S1401 in association with the identifier.

In this way, the user 471 is registered as a member of the ISP 14-1. The center server 17, to which the operations of the ISPs 14-1 through 14-n are outsourced, registers the member information and the information of the ISP (the ISP 14-1, for example) including the user 471 as a member. Operations typically duplicated and performed by a plurality of ISPs are collectively performed at a higher operation efficiency.

The connection setting process for enabling the router 12 of the user 471 to be connected to the ISP server (the ISP server 51-1, for example) is also performed in the same way as described with reference to FIGS. 13 through 18, or FIGS. 29 through 34. If a plurality of identifiers are input in step S1003 as shown in FIG. 36, a server (the ISP download server) for downloading information, such as the ISP connection ID and the password in the connection setting process, is selected in the connection setting process. More specifically, an identifier corresponding to an ISP desired by the user 471 is selected from among the identifiers stored in the ROM 102 of the router 12 in the connection setting process. Based on the selected identifier, the ISP is determined. Information such as the ISP connection ID and the password is downloaded from the ISP download server of the determined ISP.

Referring to FIG. 38, the connection setting process of the router to select the desired identifier from among the plurality of identifiers is described. FIG. 38 corresponds to FIG. 13, and steps S2001 through S2003 are identical to steps S201 through S203 shown in FIG. 13, respectively. A discussion of these steps is omitted here.

In step S2004, subsequent to step S2003, the CPU 101 of the router 12 reads and displays the plurality of identifiers stored in the ROM 102, and accepts the input of a predetermined selected identifier. More specifically, the plurality of identifiers (or the names of the ISPs corresponding to the identifiers) are displayed on a display unit (not shown) connected to the input/output interface 105 of the router 12. The user 471 selects the predetermined identifier displayed on the display unit by operating the operation unit 106.

In step S2005, the CPU 101 of the router 12 sends a request for the setting information to the simple setting server 42. The request for the setting information contains the identifier selected in step S2004. The simple setting server 42 determines the ISP (the ISP 14-1, for example) based on the identifier contained in the request for the setting information sent in step S2005. The simple setting server 42 sends the device authentication start trigger containing the URL of the ISP download server (the ISP download server 44-1, for example) of that ISP. In step S2006, the router 12 receives the device authentication start trigger.

The processes in steps S2007 through S2015 shown in FIG. 38 remain unchanged from the processes in steps S206 through S214 shown in FIG. 13, and a discussion thereof is omitted here.

The identifier corresponding to the ISP (the ISP 14-1 here) desired by the user 471 is selected from among identifiers corresponding to the plurality of ISPs stored in the router 12, and information such as the ISP connection ID and the password is downloaded from the ISP download server (the ISP download server 44-1 here) of the ISP. As a result, the user 471 is connected to the Internet 15 through the ISP server (the ISP server 51-1 here) of the desired ISP.

The above series of process steps may be performed using hardware or software. If the series of process steps is performed using software, a computer program constituting the software may be installed from a network or a recording medium to a computer assembled into a dedicated hardware, or into a general-purpose computer that performs a variety of functions by installing various programs therein.

The recording medium may be a packaged medium which is distributed separately from the apparatus to supply the user with the software program. As shown in FIGS. 2 through 8, the packaged medium may be one of magnetic disks 121, 171, 221, 271, 321, 371, and 421 (including a floppy disk), optical disks 122, 172, 222, 272, 322, 372, 422 (including compact disk—read only memory (CD-ROM), or digital versatile disk (DVD)), magneto-optical disks 123, 173, 223, 273, 323, 373, 423 (including Mini-disk (MD)), or semiconductor memories 124, 174, 224, 274, 324, 374, and 424. The recording medium also may be one of the ROMs 102, 152, 202, 252, 302, 352, and 402, or the hard disk contained in the storage units 108, 158, 208, 258, 308, 358, and 408, each of which is supplied in the mounted state thereof in the apparatus and has a computer program stored therein.

The process steps describing the software program stored in the recording medium are typically performed in the time series order stated in each flowchart. It is not a requirement that the process steps be performed in the time series order, however. Several process steps may be performed in parallel or separately.

In this specification, a system refers to an entire system containing a plurality of apparatuses.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An information processing system, comprising:
a first information processing apparatus operable to authenticate a device;
a second information processing apparatus operable to hold setting information required to connect the device to a network; and
a third information processing apparatus connected to the network based on the setting information;
the first information processing apparatus including:
a first storage unit operable to store first identification information for authenticating the third information processing apparatus, and second identification information for identifying the third information processing apparatus;
an authenticating unit operable to authenticate the third information processing apparatus based on the first identification information in response to a request from the third information processing apparatus;
a generating unit operable to generate third identification information that is used to connect the third information processing apparatus to the second information processing apparatus;
a second storage unit operable to store the third identification information in association with the second identification information;
a first sending unit operable to send the third identification information to the third information processing apparatus;
a first receiving unit operable to receive the third identification information from the second information processing unit; and
a second sending unit operable to send the second identification information to the second information processing apparatus;
the second information processing apparatus including:
a third storage unit operable to store the setting information for connecting the third information processing apparatus to the network in association with the second identification information;
a second receiving unit operable to receive the third identification information from the third information processing apparatus;
a third sending unit operable to send the received third identification information to the first information processing apparatus;
a third receiving unit operable to receive the second identification information from the first information processing apparatus; and
a fourth sending unit operable to send the setting information stored in association with the received second identification information to the third information processing apparatus; and
the third information processing apparatus including:
a fourth storage unit operable to store the first identification information;
a requesting unit operable to request the first information processing apparatus to authenticate the third information processing apparatus based on the first identification information stored in the fourth storage unit;
a fourth receiving unit operable to receive the third identification information from the first information processing apparatus;
a fifth sending unit operable to send the received third identification information to the second information processing apparatus; and
a fifth receiving unit operable to receive the setting information from the second information processing apparatus.

2. An information processing system according to claim 1, wherein the first identification information includes a device ID identifying the third information processing apparatus and device authentication information.

3. An information processing system according to claim 1, wherein the setting information includes information required to connect the third information processing apparatus to a server of an Internet service provider.

4. An information processing apparatus for providing a device to be connected to a network with setting information required for connection to the network, the information processing apparatus comprising:
an authenticating unit operable to authenticate the device based on device identification information identifying the device; and
a sending unit operable to send the setting information to the authenticated device.

5. An information processing apparatus according to claim 4, further comprising:
a requesting unit operable to request the device identification information from another apparatus that manages the device identification information,
wherein the authenticating unit authenticates the device based on the device identification information received from the another apparatus.

6. An information processing apparatus according to claim 4, further comprising:
a setting information request receiving unit operable to receive a request for the setting information the device has sent based on determining information identifying the information processing apparatus acquired from another apparatus that manages the determining information,
wherein the sending unit sends the setting information to the device from which the request for the setting information is received.

7. An information processing apparatus according to claim 6, wherein the setting information request receiving unit receives the request for the setting information when the device sends identification information identifying the information processing apparatus to the another apparatus.

8. An information processing apparatus according to claim 7, wherein the identification information is selected from among a plurality of pieces of identification information stored in the device.

9. An information processing method by which an information processing apparatus provides a device to be connected to a network with setting information required to connect to the network, the information processing method comprising:
authenticating the device based on device identification information identifying the device; and
sending the setting information to the authenticated device.

10. An information processing method according to claim 9, wherein the authenticating step includes acquiring the device identification information from another apparatus that manages the device identification information and authenticating the device based on the acquired device identification information.

11. An information processing method according to claim 9, further comprising:
receiving a request for the setting information the device has sent based on determining information identifying the information processing apparatus acquired from another apparatus that manages the determining information,
wherein the sending step includes sending the setting information to the device from which the request for the setting information is received.

12. An information processing method according to claim 11, wherein the setting information request receiving step includes receiving the request for the setting information when the device sends identification information identifying the information processing apparatus to the another apparatus.

13. An information processing method according to claim 12, wherein the identification information is selected from among a plurality of pieces of identification information stored in the device.

14. A computer program for providing a device to be connected to a network with setting information required to connect to the network, the computer program comprising:
controlling the authentication of the device based on device identification information identifying the device; and
controlling the sending of the setting information to the authenticated device.

15. An information processing apparatus connected to a network, comprising:
a receiving unit operable to receive information identifying a first apparatus that manages setting information required to connect the information processing apparatus to the network;
a requesting unit operable to send identification information identifying the information processing apparatus to a second apparatus that is to authenticate the information processing apparatus, and to request the second apparatus to authenticate the information processing apparatus;
a sending unit operable to send a result of the authentication by the second apparatus to the first apparatus; and
an acquiring unit operable to acquire the setting information from the first apparatus based on the result of the authentication sent by the sending unit.

16. An information processing apparatus according to claim 15, further comprising:
an identifying information requesting unit operable to request the first apparatus identifying information from a third apparatus that manages the first apparatus identifying information,
wherein the receiving unit receives the first apparatus identifying information sent by the third apparatus in response to the request from the identifying information requesting unit.

17. An information processing apparatus according to claim 16, wherein the receiving unit receives the first apparatus identifying information sent by the third apparatus to the information processing apparatus authenticated by the second apparatus.

18. An information processing apparatus according to claim 16, wherein the identifying information requesting unit sends identification information identifying the first apparatus to the third apparatus and requests the first apparatus identifying information from the third apparatus.

19. An information processing apparatus according to claim 18, further comprising:
a selecting unit operable to select the identification information identifying the first apparatus from among a plurality of pieces of identification information.

20. An information processing method for an information processing apparatus connected to a network, comprising:
receiving information identifying a first apparatus that manages setting information required to connect the information processing apparatus to the network;
sending identification information identifying the information processing apparatus to a second apparatus that is to authenticate the information processing apparatus, and requesting the second apparatus to authenticate the information processing apparatus;
sending a result of the authentication by the second apparatus to the first apparatus; and
acquiring the setting information from the first apparatus based on the result of the authentication sent in the sending step.

21. An information processing method according to claim 20, further comprising:
requesting the first apparatus identifying information from a third apparatus that manages the first apparatus identifying information,
wherein the receiving step includes receiving the first apparatus identifying information sent by the third apparatus in response to the request for the first apparatus identifying information.

22. An information processing method according to claim 21, wherein the receiving step includes receiving the first apparatus identifying information sent by the third apparatus to the information processing apparatus authenticated by the second apparatus.

23. An information processing method according to claim 21, wherein the identifying information requesting step includes sending identification information identifying the first apparatus to the third apparatus and requesting the first apparatus identifying information from the third apparatus.

24. An information processing method according to claim 23, further comprising selecting the identification information identifying the first apparatus from among a plurality of pieces of identification information.

25. A computer program for processing information in an information processing apparatus connected to a network, comprising:
controlling the reception of information identifying a first apparatus that manages setting information required to connect the information processing apparatus to the network;
controlling the sending of identification information identifying the information processing apparatus to a second apparatus that is to authenticate the information processing apparatus, and the requesting of the second apparatus to authenticate the information processing apparatus;
controlling the sending of a result of the authentication by the second apparatus to the first apparatus; and
controlling the acquisition of the setting information from the first apparatus based on the result of the authentication sent in the sending control step.
